(19) United States
(12) Patent Application Publication
(10) Pub. No.: US 2007/0220907 A1
(43) Pub. Date: Sep. 27, 2007

(54) REFRIGERATION MONITOR UNIT

(76) Inventor: Gregory A. Ehlers, Dacula, GA (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/688,523

(22) Filed: Mar. 20, 2007

Related U.S. Application Data
(60) Provisional application No. 60/784,502, filed on Mar. 21, 2006.

(51) Int. Cl. F25B 49/00; G01K 13/00

(52) U.S. Cl. 62/126; 62/129

(57) ABSTRACT

A control unit is attached to or embedded within a refrigeration appliance to monitor electric power voltage and/or frequency supplied by the mains. If the unit detects a sag or peak in either the voltage or frequency, the control unit either separates any high demand elements of the appliance from the mains to reduce demand in a sag or energizes the elements in a peak. When the control system separates the refrigeration compressor from the mains, a food spoilage monitoring system monitors the food storage compartments. This system utilizes food industry temperature and time algorithms to ensure the food does not spoil. If food spoilage could occur, the unit re-energizes the compressor to allow it to lower the temperature provided the power is sufficient to operate the compressor unit without damaging it. Once the sensed temperature is restored to a safe level, the unit separates the compressor from the mains.

### CROSS REFERENCE TO RELATED APPLICATION(S)

This application is based on and claims priority to U.S. Provisional Patent Application No. 60/784,502, filed Mar. 21, 2006.

### FIELD OF THE INVENTION

The present invention relates generally to a system designed to protect the electric power delivery grid and reduce consumption during periods of high demand and/or when there is instability in the generation sector. Specifically, the invention removes a refrigeration load from the electricity delivery system until the grid stabilizes and returns to normal operation. During the time when the refrigeration appliance is separated from the grid, the system monitors the temperature of the cold food storage area as well as the freezer compartment to determine if food spoilage may occur. The system takes corrective action, if possible, to prevent spoilage from occurring.

### BACKGROUND OF THE INVENTION

As a result of the rising cost of fuel and the increased demand for electric power, energy providers are being pressed to run their units as efficiently as possible. One element of the generation industry that is under examination is the element known as “spinning reserve”. Spinning reserve is a block of generation that is on line and ready to deliver power to the grid but is not needed to meet the current demand. Spinning reserve exists so that if the largest generating unit operated by an energy provider should go offline unexpectedly, the system would be able to handle the loss without interruption. This practice is common in the US but is not necessarily practiced globally. Up until now, maintaining spinning reserve was the only safeguard available to energy provides to ensure reliable delivery of power.

Following the introduction of low cost microcomputers, it is now possible to put power quality monitoring devices on major appliances and program these devices to automatically disconnect major demand elements from the power grid if the quality of power on the grid falls out of an established acceptable range.

Experts in the industry believe that monitoring incoming power frequency is sufficient to deliver an appliance level grid protection safeguard system. However, it is well known that utilities will often reduce voltage on the delivery systems when capacity gets tight. When the reduction of voltage on the delivery system can not keep up with demand on a high demand day, the next step taken is load shedding or demand side management. Utilities often have large commercial and industrial customers that agree to drop large quantities of load when called upon by the utility. In exchange for this cooperation, the utility will typically provide the customer with incentive rates to subsidize for the inconveniences.

Other programs include on site generation programs where commercial or industrial customers will exit the grid and switch to an emergency generator when called up and in this way provide relief to the energy provide and the population in general. Here again, the energy provider pays the commercial or industrial customer for participating in such a program.

Another program that is offered by energy providers is a residential demand side management program where utilities pay residential customers a fixed monthly amount to allow them to interrupt their heating, air conditioning, water heaters or pool pumps when needed to reduce demand. All of these programs are designed to do one thing, remove demand from the system and help the energy provider get through a period of high demand.

### SUMMARY OF THE INVENTION

It is a purpose of this invention to introduce a system that will monitor the power quality input to a residential refrigeration appliance and separate the major load elements of the appliance from the grid should a loss of power quality occur. This loss of power quality can be a dip in voltage or frequency or a combination of both. In addition, the invention will monitor temperatures in the appliance to ensure that food quality is not compromised. If the possibility of food damage is detected, the system will reconnect the refrigeration compressor and controls to the mains, as long as doing so will not damage the appliance, thus permitting the appliance to operate long enough to avoid damaging the food. If power quality is not sufficient to operate the refrigeration compressor, the system will monitor and report on food damage levels based on time and temperature standards established by the food industry or regulating governmental agencies.

In a similar fashion, if power quality should indicate a spike in voltage or frequency, indicating a excess of power on the delivery system, the appliance may either separate from the grid to protect it from the spike or it may engage heating elements normally used in defrost or cabinet heating functions to help absorb the spike which normally will be corrected in seconds.

In one general aspect, a refrigeration appliance monitoring circuit includes an incoming power quality monitor and a sensor that senses a condition within a compartment of the appliance. The monitoring circuit monitors the power quality and the sensed condition, such as temperature, and provides a communications circuit with a signal corresponding to the sensed condition. The unit also may include a power supply connected to power the monitoring circuit upon loss of power.

The primary function of the system is to continuously monitor the incoming power to determine its quality. The quality of the power is determined by one or more factors. The system can monitor and measure voltage levels on the mains, frequency of the incoming power or both. The system monitors one or both of the incoming power quality metrics and compares the measured values against a defined range or threshold values to determine if an alarm condition exists. For voltage, the normal value for a single phase outlet in the US would be 120 volts. This will be different in other countries depending on their standard. The most common voltage levels are 120 and 240 volts.

The other measure the system monitors is frequency, which in the US is 60 cycles per second, while in other areas of the globe 50 cycles per second is also found. The system is capable of operating with any voltage and frequency. It is important, however, to realize that voltage drops as a function of distance traveled so voltage at a sub station buss bar may register 120 volts but as it travels from that location, there will be voltage drops. As a result, the voltage monitoring of the system may be fixed or may be learned, based on the implementation. If it is fixed in design, an example would show that 120 volts is normal; however, a reduction of −20 volts to 100 volts might indicate a low voltage disconnect trigger threshold.

In a similar fashion, a high voltage trigger threshold could be set at +20 volts or 140 volts at the monitoring point, indicating a high voltage disconnect or forced load energizing trigger level. In either case, the system would manage the connection of the appliances high demand loads to the mains.

In a learned voltage environment, the system will determine the normal voltage at its installed location. The “normal voltage” for any location will be dictated by its distance from the sub station and the line losses encountered in the distribution system. Once installed, the system will monitor and record the sensed operating voltage at the location for a defined period of time and then keep a rolling average going forward to account for external factors.

It should be noted that even in a learned voltage installation, there will always be a minimum and maximum threshold value at which the appliance can operate without being damaged. As a result, based on the design specifications of the appliance, minimum and maximum values for voltage will exist. The power quality monitoring and control system will always remain connected to the mains. In that way the system will be able to disconnect the appliance main loads when power quality problems arise and will be able to reconnect the appliance main loads when incoming power quality returns to a normal state.

Control of the main loads will preferably be accomplished through the control systems already existing in the appliance. In this way, no additional control relays will be needed, thus reducing the overall cost of the implementation. The system can be separate from the appliances original control system or can be fully integrated into the appliance control system.

An important aspect of electric power delivery is that voltage may sag by a significant percentage in comparison to frequency. As mentioned earlier, voltage reductions and fluctuations may occur within a broad range and only when an established low or high threshold value is exceeded will a disconnect action occur. Frequency on the other hand is a much more critical measure and a sag in frequency is an indication that there is a serious problem. In the US market, a drop in frequency from 60 cycles per second to 59.8 cycles per second could be considered as a trigger level at which to drop the appliances main demand load. In addition, with frequency it is essential to drop load within 2 or 3 cycles of identifying the trigger or alarm condition. Any drop in frequency is an indication that the power delivery system is under a significant load and will go into a forced shutdown if the frequency typically drops below 59.7 or 59.6 cycles per second.

The system is designed to disconnect any high demand loads within 1/60 or 1/30 of a second from the time it is detected. In a frequency sag or peak it is important to note that the system will remain in full operation connected to the incoming power source. Unlike voltage sags or peaks, frequency variations rarely occur in most delivery systems. However when they do occur, they are usually corrected quickly or the delivery systems crashes cutting power to all users.

Restoration of loads to the delivery system following a power quality disconnect event must also be managed in a controller manner. It is therefore a feature of the system to manage the load pickup that will take place when reconnection occurs. To accommodate this cold load pickup, a random number generator is used to compute a forced delay time to wait before the reconnection occurs. This forced delay permits the many loads that disconnected from the mains as a result of a power quality disconnect event to reconnect without placing a huge instantaneous demand on the system.

The monitoring circuit may include a processor that determines when food spoilage will occur based on the sensed condition. The monitoring circuit may send a signal through the communications circuit to indicate when food spoilage will occur or that food spoilage has occurred.

A battery may be connected to the monitoring circuit in case all power to the appliance is lost. The monitoring circuit monitors power supplied to the appliance and, if power is interrupted, may send a signal using the communications circuit. The signal may indicate that no power is being supplied to the appliance. The signal also may indicate when food spoilage will occur.

Other features and advantages will be apparent from the description, the drawings, and the claims.

### BRIEF DESCRIPTION OF THE DRAWINGS

The drawings illustrate the best mode presently contemplated of carrying out the invention. In the drawings:

FIG. 1 is a block diagram of an exemplary automation system.

FIGS. 2 and 3 are block diagrams of a control server of the system of FIG. 1.

FIG. 4 is a diagram of a universal controller of the system of FIG. 1.

FIG. 5 is a perspective view of an exemplary communications module of the system of FIG. 1.

FIG. 6A is a perspective view of an exemplary retrofit plug.

FIGS. 6B-6D are block diagrams of a retrofit plug of the system of FIG. 1.

FIGS. 7A-7C are exemplary screen shots of touchpad user interfaces of the system of FIG. 1.

FIG. 8 is a block diagram of a distributed video network.

FIG. 9 is a block diagram of a retrofit damper system.

FIG. 10 is a block diagram of a retrofit damper of the system of FIG. 9.

FIG. 11 is a block diagram of a zone controller of the system of FIG. 9.

FIG. 12 is a block diagram of function blocks for home manager software.

FIG. 13 is a screen shot of the home manager temperature control of the software of FIG. 12.

FIG. 14 is a screen shot of the home manager kitchen assistant of the software of FIG. 12.

FIG. 15 is a block diagram of a metering network.

FIG. 16 is a screen shot of a remote monitoring service.

FIG. 17 is a screen shot of a temperature monitoring interface.

FIG. 18 is a block diagram of a central locking network.

FIG. 19 is a block diagram of a security network.

FIG. 20 is a block diagram of a lighting network.

FIG. 21 is a block diagram of a heating network.

FIG. 22 is a block diagram of a zone controller and a heating network.

FIG. 23 is a screen shot of a home manager heating control interface.

FIG. 24 is a block diagram of an appliance control system.

FIG. 25 is a screen shot of an exemplary virtual control panel of the system of FIG. 24.

FIG. 26 is a block diagram of a refrigeration appliance including a monitoring circuit; and

FIG. 27 is a flowchart illustrating the operating steps performed by the monitoring circuit of the refrigeration appliance.

Like reference symbols in the various drawings indicate like elements.

### DETAILED DESCRIPTION OF THE INVENTION

An automation system, which may also be referred to as a building control (BC) system, may be used to automate a home, an office, or another type of commercial or residential building. In the residential context, the BC system establishes a home network that controls, coordinates, facilitates, and monitors user-designated activities within the home. The BC system provides compatibility between external and internal networks, systems, and appliances, and is modular in construction to allow easy expansion and customization. The BC system can be retrofitted for use in existing structures and legacy appliances without the need for drastic remodeling, added wiring, or complicated installation/customization, and can be installed by a homeowner with minimal instruction. Professional installation and maintenance also are simplified, so as to avoid the high costs typically associated with custom home automation.

The modularity of the BC system provides for easy customization for either commercial or residential use. For residential applications, system elements may be sealed for easy installation, configuration, and aesthetic appearance. Expansion within the residential applications can be accomplished by adding new modules to the system. On the other hand, for commercial or advanced residential applications, the system can be custom configured and expanded through the additional use of expansion boards, PCMCIA cards, or plug in solutions. Although the following examples are primarily described with reference to home applications, the described devices and concepts also are applicable for commercial use.

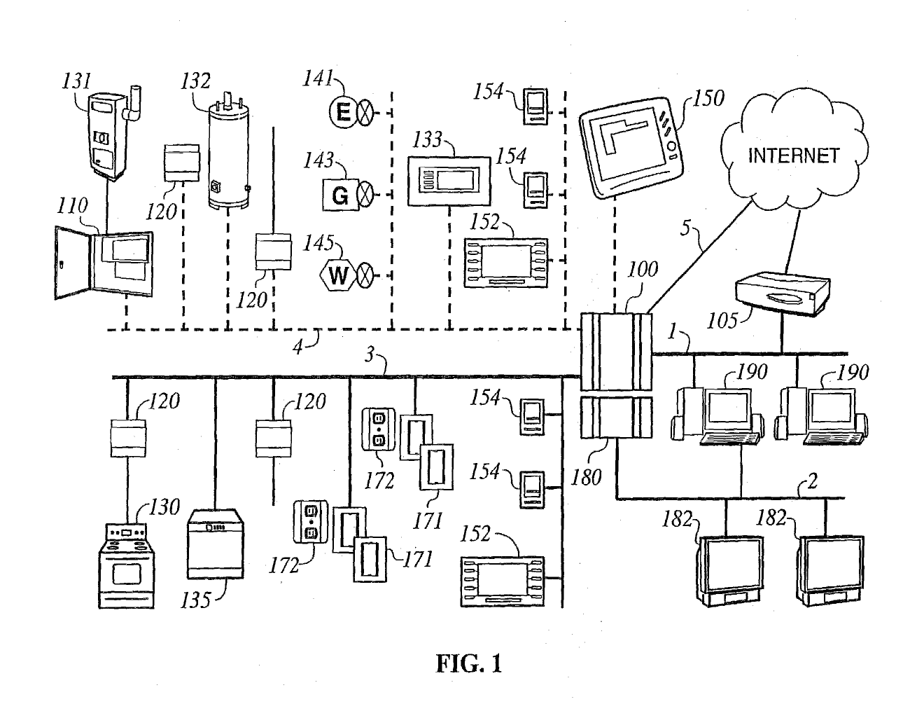

Referring to FIG. 1, an exemplary BC system is based around a control server 100 that manages a number of primary networks including: an internal home network 1 (e.g., a USB or Ethernet network), a video distribution network 2 (e.g., Peracom AvCast System), a power line carrier (PLC) network 3, a wireless radio frequency (RF) communications network 4, and an Internet portal 5 (e.g., a DSL modem). BC system devices attach to the control server 100 through one of these networks, and each network services a different aspect of home automation.

The home network 1 can include a residential broadband gateway 105 for high-speed interaction with the Internet and service providers. In addition, a number of computer systems 190 can be connected to provide access to the control server 100 and between the computer systems 190. The home network 1 can be implemented using any LAN system, such as, for example, an Ethernet system. The computer system 190 can be used as an interface for controlling home automation and running home automation software.

The video distribution network 2 can include an AvCast subcomponent 180 that plugs into the control server 100 to coordinate multimedia activity between, for example, video monitors 182 and a satellite TV system 181. The video distribution system 2 also can act as an interface to the control server 100.

The PLC network 3 provides control of switches 171, power outlets 172, and smart appliances 135. In addition, a number of communications modules 120 can be used to communicate with legacy devices, such as a range 130. Retrofit plugs 125 also can be used within the PLC network to provide communication with legacy devices. A number of different interfaces, such as, for example, touch pads 152, 154 and portable tablet 150, can be used to provide for user interaction with the control server.

The RF network 4 includes communications modules 120, legacy appliances 132, and interfaces 152 and 154. In addition, a universal controller 10 can be used to control appliances, such as a furnace 131. The RF network 4 can be connected with sensors 141, 143, and 145 to monitor home utilities such as electricity, gas, and water, respectively. A smart thermostat 133 and a damper system can be used to control and optimize home heating and cooling.

The Internet portal 5 allows access and control of the BC system from a remote location. In addition, service providers may remotely monitor appliances, usage, and security within the home. New applications and upgrades of existing software can be obtained through the Internet.

The control server 100 features pre-configured control function blocks or objects, in addition to user defined control strategies, that run on a real time control engine capable of executing combinational and sequential logic control. The control engine may be application specific or generic depending on the size and the intended purpose of the BC system in which the control engine is implemented. The control function blocks executed by the control server 100 are designed to operate in a number of modes, such as, for example, an away mode, a sleep mode, and a vacation mode, among others. The control server 100 operates appliances and subsystems based on the BC system's current operating mode. For example, when entering the away mode, the control server 100 can activate the security system and turn down the heat or the air conditioning. In addition to modes that can be selected and transitioned, “hard-wired” functions are provided to initiate actions based on recognition of certain external conditions. One example of such an action is the flashing of red screens on all televisions and displays in a home when a fire alarm is tripped.

The control server 100 also provides for protocol conversion. For example, if an attached appliance has a stripped-down protocol, the control server 100 adds the missing elements to make the appliance appear to be compliant with a desired industry standard protocol. Where the physical layer necessary for communication with a device is not available in the control server 100, add-on units may be used to attach the control server to the device. The control server 100 accommodates multiple protocols and physical layers through communications modules 120 attached between devices using foreign protocols or physical layers and the control server 100. Similarly, smart modules, retrofit plugs, and universal controllers may be used to provide the function of protocol conversion. The control server 100 interfaces with any of the system graphic user interfaces (GUIs), PC networks, Internet, and all other portions of the BC system as described in greater detail below.

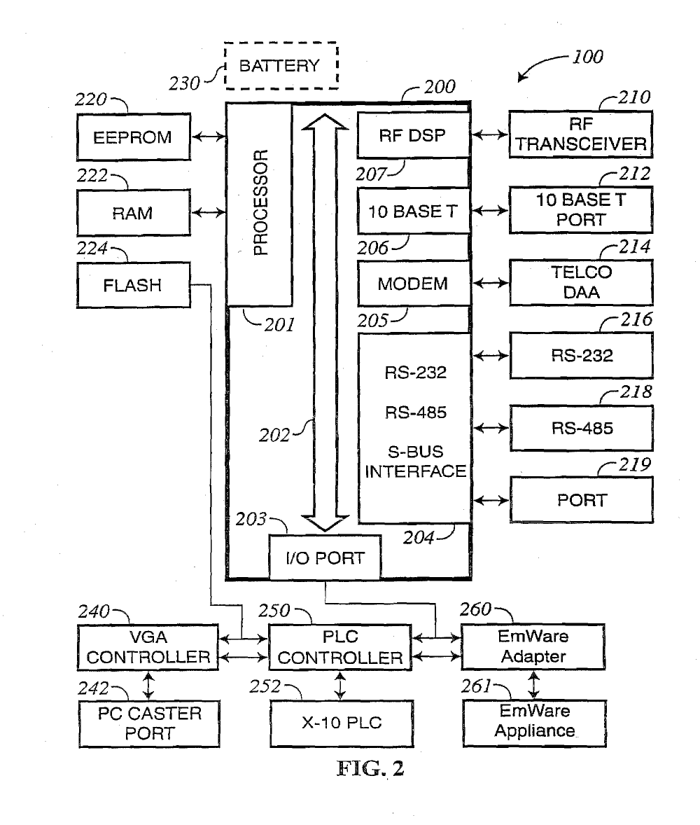

The control server 100 is modular in design and can be scaled with regard to size, functions, and hardware desired for a specific implementation. One example of a control server 100 is shown in FIG. 2. As shown in FIG. 2, the control server 100 includes a processor 200. The processor 200 is connected to a board with a communications bus 202, an I/O port 203, and interfaces including a RF digital signal processor 207, a 10 BASE-T interface 206, a modem 205, and a serial interface 204. The interfaces provide communication between the control server 100 and the primary BC system networks 1-5.

The processor 200 also is connected to a flash memory 224, a RAM 222, and an EEPROM 220. An optional power source (RTC xtal and Battery) 230 can be used to power the control server 100 in the event of loss of power. A number of communication ports are connected with the various interfaces. The communication ports can include a 10 BASE-T port 212, a TELCO DAA 214, a RS-232 port 216, a RS-485 port 218, and an S-BUS port (or USB port) 219.

In addition, a PLC controller 280 and an EmWare Adapter 260 are connected to the communications input/output port 203. These devices may be configured on the board or as add-on modules. The EmWare adapter 260 can be used to communicate with and control appliances or systems that use an EmWare communications protocol. Other adapters for other communications protocol or systems can be provided in an original device or as add-on, plug-in applications. A VGA controller 240 is provided for connection with a PC caster port 242.

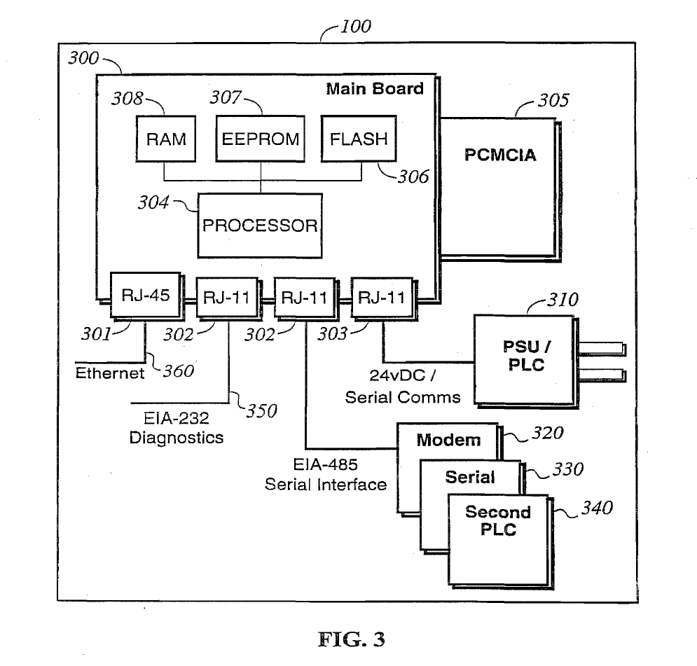

As shown in FIG. 3, the control server 100 also can be implemented as a main board 300 with optional add on boards and PCMCIA slots. The main board 300 includes an Ethernet connection 301, a serial I/O port 315, and an optional slot for a PC card 305. Daughter boards are connected to the main board using a system bus connector. A daughter board typically includes an eight-way serial interface card and a four-way Ethernet card, with an optional slot for a PC card. The main board 300 can be implemented using a Motorola MPC860 PowerPC core 304, a memory (including flash 306, DRAM 308, NVRAM 307), and I/O including: Dual SCC channels with HDLC interface, two status LEDs, two Tx/Rx pair communication status LED indicators, a debug RS-232 serial port, a PCMCIA slot, 10/100 Base T physical interface connector, an EIA-232 serial port, an EIA-485 serial port, and an EIA-485 serial port with 24V PSU input.

External connections from the main board 300 include a single RJ-45 connector 301 for an Ethernet connection and a number of RJ-11 connectors for serial communications. The first RJ-11 connector 303 can support two connections for 24V DC serial communication for PLC 310 and a second connector 302 for an EIA-485 serial interface. The serial interfaces on the main board 300 can use RJ-11 connectors. PLC interfaces to the main board, as well as other boards, are made through a serial interface to, for example, external communications modules. The primary PLC interface 310 is enclosed inside the external transformer housing that provides 24V DC to the control server.

Functionally, the Ethernet interface 360 to the main board 300 is the primary WAN or broadband interface. Typically, the interface 360 can be connected to a cable modem or a DSL modem and can provide a firewall to secure data access. The EIA-232 interface 350 is provided for programming and debugging of the control server 100 in the field. The free EIA-485 interface allows flexible customization of the control server 100 or connection to an external POTS modem, a serial interface (third party device), or a second PLC.

The control server 100 main board 300 can accommodate a number of additional EIA-485 interfaces (e.g., eight interfaces). The additional interfaces can provide connection to third party devices, such as security panels, lighting control systems, HVAC zoning systems, and others. The additional interfaces also can be used for connection to external bridges, such as additional PLC interfaces, RF subsystems, communications modules, and retrofit plugs.

The Ethernet board (not shown) on the main board 300 includes four 10/100 base T Ethernet interfaces. The four interfaces provide connections for two secure LAN connections, one unsecure LAN connection, and one unsecure WAN connection.

The control server video board (not shown) can include the following interfaces: video out/VGA out, video in, dual USB—printer, keyboard/mouse interface, IR interface, and PCMCIA slot (optional). The video board provides video I/O as well as IR command transmission. A keyboard and mouse combination can be used with the video board through a USB or USB-to-RF interface (in the case of a wireless keyboard or mouse). A second USB connector can interface with printers, digital cameras, and other peripheral equipment. Functionally, the board accepts video input and digitizes the video for use by the rest of the BC system using the MPEG4 standard. The video board also provides video output as a TV channel for broadcast on connected televisions within the home.

Universal Controller

The universal controller 110 is an optimized form of the control server 100. The universal controller 110 performs a single dedicated task, such as HVAC control. As a result, the universal controller 110 includes only the input and output features that are necessary for the dedicated task. The universal controller 110 can be used in a stand-alone configuration with access through remote dial-up, Internet access, and/or a touchpad interface. The universal controller 110 also can be controlled and monitored by the control server 100. The universal controller 110 communicates with the control server through the RF or PLC networks or by directly wired serial communication. The universal controller 10 can be used to handle applications that are pre-packaged for physical distribution, that have outgrown the capability of the control server 100, or that have special features not handled by a standard control server 100. In addition, the universal controller 110 can be implemented as a daughter board to the control server 100.

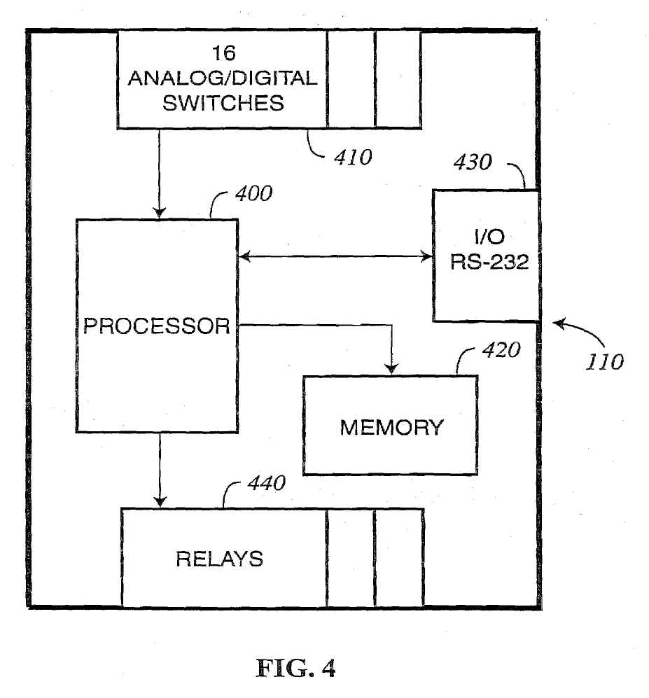

According to the example shown in FIG. 4, the universal controller 110 includes a processor 400 to which a memory 420 is connected. The memory includes communications software for the remote uploading and downloading of data and software for control of specific attached subsystems, such as, for example, HVAC control. The universal controller 110 also includes 16 analog/digital switches for receipt of signals from sensors. An RS-232 communication interface 430 is provided for PC, modem, and other communication with serial communication ports of other devices. Twenty four relays configured in pairs of twelve are provided as output 440. Each relay in a pair can be configured for an individual device that is powered from a common source.

Control Modules

Referring again to FIG. 1, control modules (e.g., 120 and 125) allow legacy appliances that have already been purchased by a homeowner or commercial operator to be integrated into a home automation system. This is important because appliances are expensive and have relatively long operational lives. As a result, appliances typically are not replaced until failure. Therefore, for existing appliances to be incorporated in a total home or commercial automation system, an interface is needed to allow communication with the automation system so that a user is not forced to buy a network ready appliance. The control modules provide such an interface in a form that can be installed easily by the homeowner or business operator.

In addition, manufacturers may not wish to sell devices that are network/system compliant due to the added cost associated with outfitting the appliance with the necessary software and control circuitry. Therefore, a control module can be inserted into an appliance aftermarket, or by the manufacturer, to provide network protocol compliance.

Two examples of control modules are the appliance communications module and the retrofit plug. The appliance communication module acts a bridge between the control server (or remote monitoring service provider) and an appliance by providing protocol conversion that is specific to the appliance. The communication module also allows the control server to control the appliance. The retrofit plug provides for remote monitoring and diagnosis of an appliance, and is easily installed with any appliance.

Appliance Communications Module

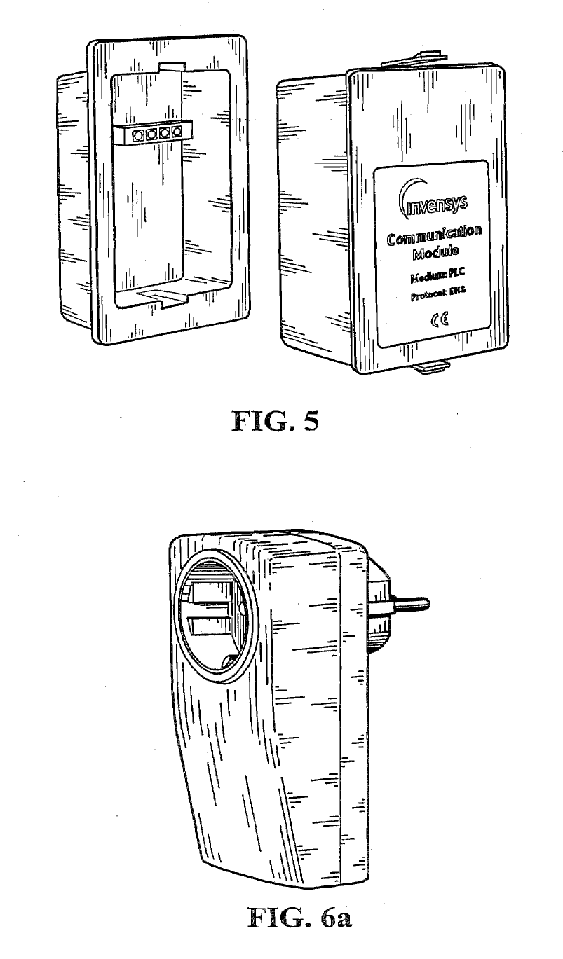

The appliance communications module 120 is adapted to be received by an appliance having an appliance controller. The communications module 120 includes a communications protocol translator. The communications protocol translator translates signals received from a communications media into appliance controller signals. The translator also translates appliance control signals received from the appliance controller into a communications protocol to be output to an appliance communications network. The communications module 120 also can include a power line transceiver connected to the communications protocol translator and a power line driver connected to the transceiver and the connector. The communications module's connector is electrically coupled to the appliance controller. Alternatively, the communications module 120 can include a radio frequency (RF) communications module 120 is shown in FIG. 5.

The protocol translator translates signals received from the network into appliance controller signals. The translator also translates received appliance control signals according to a communications protocol to be output to the network through the modem or transceiver.

A network ready appliance is also provided. The network ready appliance includes an appliance controller having a communications port. The appliance also includes a cavity, defined by walls, that is adapted to receive the communications module 120. An opening in a wall of the appliance allows access to the cavity. A connector is attached to one of the cavity walls. A communications line connecting the communications port and the connector also is provided. The connector is electrically coupled to the appliance controller or to the main power supply. The network ready appliance further includes a detachable cover provided over the opening to protect a user from electric shock. Alternatively, the appliance connector can be recessed in a cavity to protect the user against shock.

The communications module is described in detail in U.S. patent application Ser. No. 09/511,313 title “COMMUNICATION MODULE” which was filed Feb. 23, 2000, and is incorporated by reference in its entirety.

Retrofit Plug

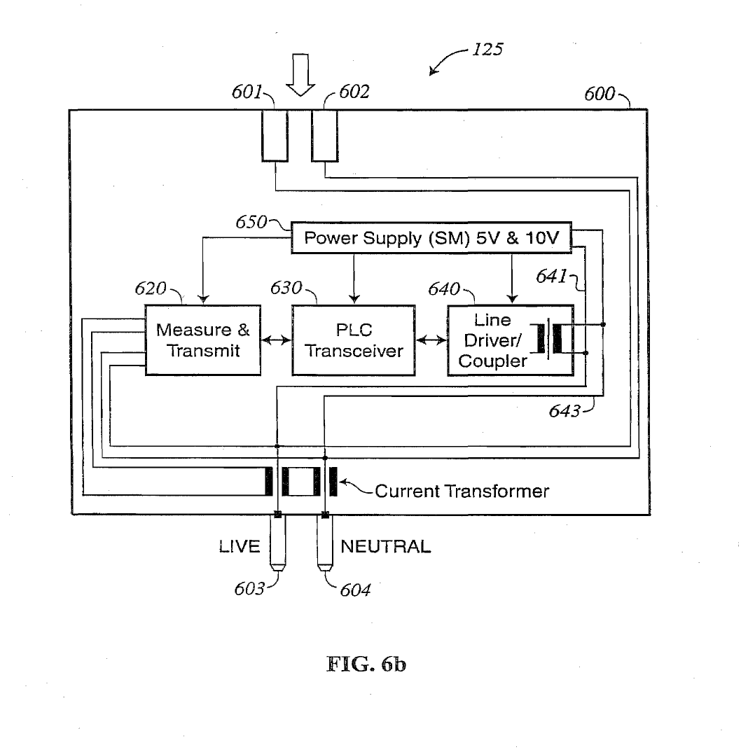

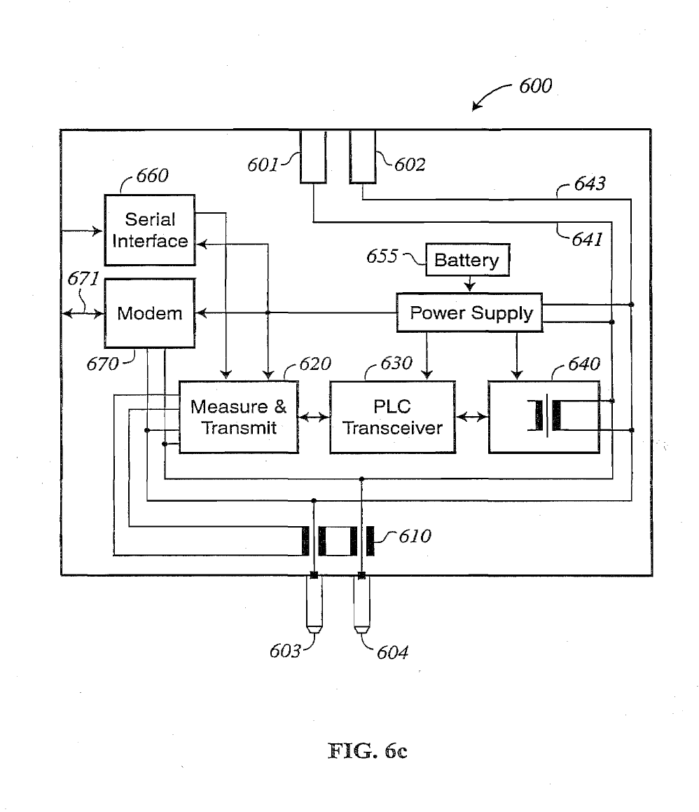

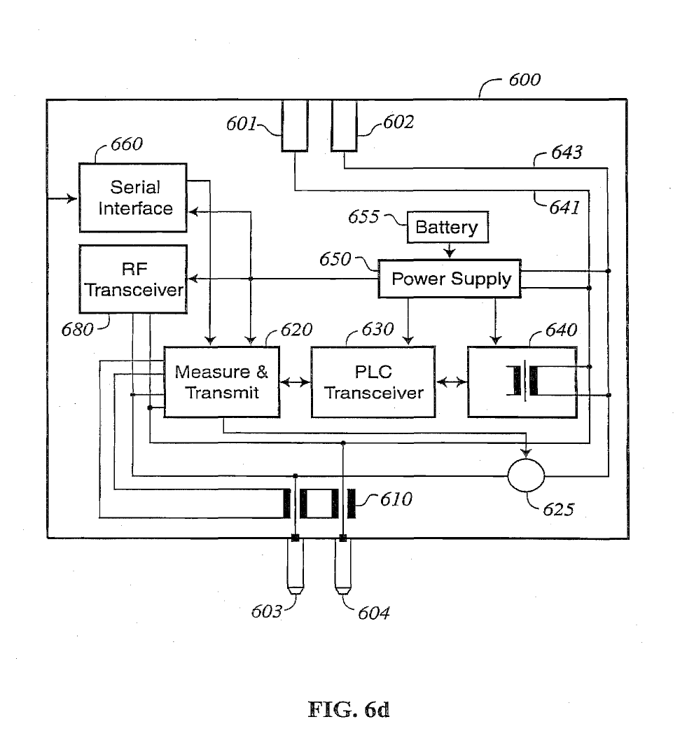

The retrofit plug 125, shown in FIGS. 6A-6D, is a plug-through device that is either attached in line with the main appliance electrical supply or internally in line with a main control board interface connector of an appliance 130. As shown in FIG. 6A, the retrofit plug can be installed on legacy equipment by simply connecting the retrofit plug 125 to the pins of the appliance that are used to supply power to the appliance. As a result, a legacy appliance can be easily incorporated into a network to allow monitoring and control of the appliance by a homeowner without the need for custom or professional installation.

As one example of an internal connection, control signals inside certain refrigerators pass through a marshalling connector connected to the main control board. By connecting a retrofit plug to this connector, all signals within the refrigerator can be tapped for diagnostic data. The diagnostic data may be sent to the control server 100 that monitors the appliance 130, for example, through the PLC network 3. The data gathered from the appliance 130 can be stored by the control server 100 or downloaded to a remote database maintained by a service provider.

In a standalone application, the control server 100 can be replaced by a gateway connected to a PLC network. Data from the retrofit plug can be sent through the PLC network to the gateway. The gateway transmits the data to a service provider monitoring the appliance 130. The plug may operate as a stand-alone unit by equipping the plug with a modem to communicate with an external computer (e.g., as provided by a monitoring service). The retrofit plug 125 also can be equipped with an RF transceiver so that the plug may be incorporated in a wireless network 4 for monitoring and control of an associated appliance.

FIG. 6B shows an exemplary retrofit plug 125 that provides an interface between an appliance's electronic control system and the control server 100. The retrofit plug 125 has an outer housing 600 made of, for example, an electrically-insulative plastic (class II) or (class I). The retrofit plug can include a number of couplers. For example, the housing 600 includes slots 601 and 602 for connection with pins from the appliance 130, for example, on a power cord, that are used to supply power to the appliance 130. Pins 603 and 604 extend from the housing for connection with the mains that supply power to the appliance 130. Although only two pins and two slots are shown in the example of FIGS. 6B-D, additional pins and slots may be included as needed to be compatible with any particular appliance's power supply. For example, a retrofit plug could attach to a three pin connector by adding an additional slot and pin for an earth connection or to a four pin connector having two live pins, a neutral pin, and a ground pin by adding slots and pins for the second live pin and the earth pin.

The retrofit plug 125 includes a power supply 650 for supplying power to a measure and transmit circuit 620, a power line communication (PLC) transceiver 630, and a line driver 640. The power supply 620 powers the retrofit plug's components (620, 630, and 640) by converting the appliance AC voltage (e.g., 100V to 264V and 50/60 Hz) to a 5/10V DC voltage. The power supply 650 receives power from pins 603 and 604 through lines 641 and 643.

The retrofit plug includes monitoring circuitry. For example, a measure and transmit circuit 620 is connected to a current transformer 610 to measure the current being drawn by the appliance attached to the retrofit plug 125. Other circuitry that could be used to monitor the current drawn by the attached appliance includes a Rogowski coil or a shunt.

The measure and transmit circuitry 620 may include a processor (e.g., an ASIC, a DSP, a microprocessor, or a microcontroller) and memory (such as an integrated circuit (IC) memory or a flash memory). The measure and transmit circuit 620 can simply monitor and report the current drawn by the attached appliance 130. Specifically, the measure and transmit circuit 620 may monitor current draw timing, duration, and amount. In more sophisticated applications, the measure and transmit circuit can be upgraded to perform bi-directional communication by translating between a communications media protocol used by the control server 100 and the appliance's control protocol. In addition, if the appliance's load current is measured, an indication of power can be derived from the square of the load current. Line voltage may be measured and multiplied by the load current to measure true power consumption.

The current draw data or power data can be stored by the measure and transmit circuit 620. The measure and transmit circuit 620 can be programmed to periodically send the measured data to the control server 100 as part of a general monitoring function, such as, for example, energy management and logging functions. In addition, the measure and transmit circuit 620 can be programmed to compare measurement data to specific electronic signatures stored in a table in the memory of the retrofit plug 125. The measure and transmit circuitry can send messages to the control server 100 in response to events which indicate a state of the appliance 130 requiring some further action (e.g., shut off power).

The retrofit plug 125 also includes a communications circuit. The communications circuit sends data from the measure and transmit circuit to a remote processor, such as, for example, the control server 100. The communications circuit may also receive signals from a remote processor, such as, for example, the control server 100. The communications circuit may include a transmitter and a receiver or a transceiver, a power line communication (PLC) transceiver 630, and a line driver 640. Measurement data is supplied to the PLC transceiver 630 and are coded for PLC transmission on the PLC network 3. The PLC transceiver 630 operates a line driver 640. The line driver 640 places the measurement data as PLC coded signals on lines 641 and 643 according to a network protocol.

The PLC coded signals are supplied by the retrofit plug to the external power circuit that supplies power to the appliance. The control server 100 monitors the external power circuit to receive the PLC coded signals. In this way, the control server 100 can monitor appliances connected to the external power circuit and the appliances can exchange data with the control server 100 or other appliances connected to the network.

The control server 100 or a remote monitoring service is able to perform diagnostic interpretation about the appliance 130. In this manner, the BC system can determine the health of the appliance, the appliance's current function (e.g., how many burners are on, oven capacity, temperature monitoring in a refrigerator, and washer and drier cycles including length), and device failure (including cause). For example, if a current signature or power usage for the light bulb in a refrigerator is detected as being active over an extended period of time, the control server 100 can determine that an open door condition exists and can generate a message for display on an interface 150 to alert the user to shut the door.

The retrofit plug 125 also can include a power-switching device under control of the measure and transmit circuit 620. The power-switching device enables remote shutdown of the attached appliance, for example, through the retrofit plug 125, if a situation occurs that may damage the appliance if operation is continued or if a hazardous condition may result from continued operation. The power-switching device also can permit dimming and variable current flow regulation for remote control of the appliance.

The retrofit plug 125 can be designed specifically for a particular appliance. As a result, the retrofit plug 125 can perform sophisticated diagnosis, monitoring, and control specific to the appliance. Alternatively, the retrofit plug 125 can contain sufficient memory that control data or programs can be downloaded to the plug from the control server 100 through the PLC network. The software and data may be provided directly by the service provider. Software also may be installed in the field using a flash memory chip that is inserted into the retrofit plug 125.

As shown in FIG. 6C, an optional battery 655 can be connected with the power supply 650 to provide power to components of the retrofit plug in the event that power is lost. The battery may be a rechargeable battery that charge while the retrofit plug is supplied with power, if the battery is not in a fully charged state.

A serial port or other communications interface also can be provided in the retrofit plug to provide additional communication capabilities. The serial interface may be used for connection with another sensor to provide additional data about the device connected to the retrofit plug 125. The additional data can be transmitted to a remote monitoring device using the PLC network.

Other types of communications media also can be supported by the retrofit plug. As shown in FIG. 6C a modem 670 is provided within the retrofit plug 125 to provide communication to a network through a phone line. Alternatively, a wireless modem could be used for remotely located appliances where a phone line may not be available. The processor in the measure and transmit circuit 620 handles modem dial-up to an external network and provides buffering for the two-way data transfer on line 671. A phone line can be attached to the data transfer line 671 by adding a RJ connector in the housing of the retrofit plug 125. The modem 670 does not have to be included within the retrofit plug 125, instead, the modem can be a snap-on attachment to the retrofit plug 125.

As an example, the modified retrofit plug with serial port and modem can be used to monitor a commercial freezer. A retrofit plug 125 is installed on the main power supply to the freezer. In addition, a temperature sensor is fitted inside the freezer compartment to measure the freezer's interior temperature. The temperature sensor is attached to the retrofit plug 125 using the serial port. The battery provides power capability to the retrofit plug 125 and its components. In addition, the retrofit plug 125 has a telephone modem. In this case, if the main power supplied to the freezer fails and the freezer temperature approaches 32 degrees, the retrofit plug 125 can sense the rise in temperature using the remote temperature sensor and dial the operator or monitoring service to alert that food spoilage is possible.

Operator Interfaces

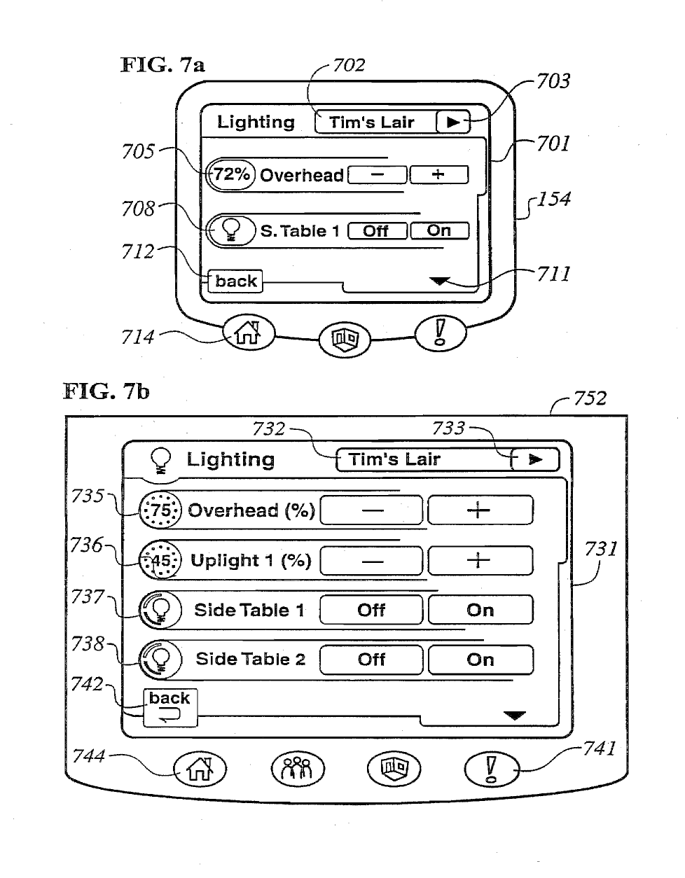

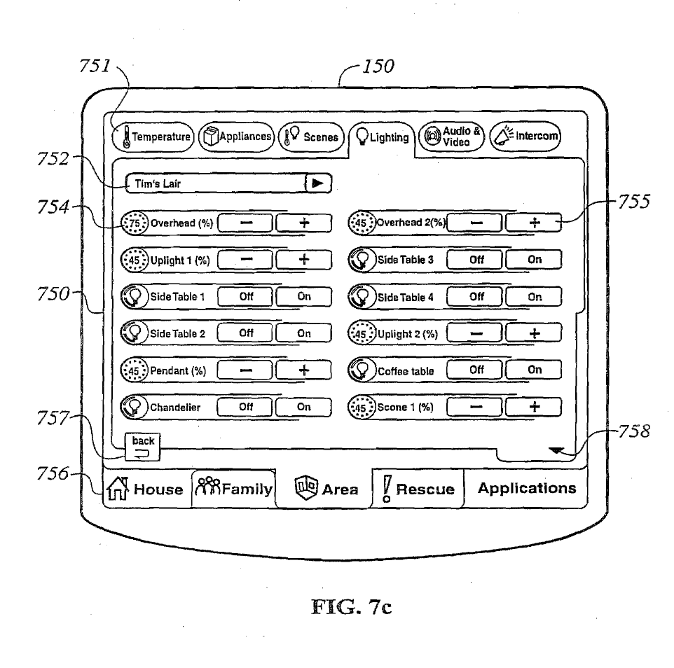

Operator interfaces that can be used with the BC system include, for example, single room touch pad, small touchpad, standard touchpad, portable tablet, PC, and web enabled phones. In general, the look and feel of the operator interfaces is consistent between each interface where possible, and may look as is shown in FIGS. 7A-7C.

Small Touchpad

The small touchpad 154 includes a display, such as, for example, a 2.6″ color TFT display. The display 701 shows the controls for lighting in a room. A room selection bar 702 displays the area that the small touchpad is being used to control. An arrow button 703 allows the user to switch between multiple areas. Control bars are used to control appliances within the area, such as, for example, a control bar 705 for overhead lighting and a control bar 708 for a table light. The amount of overhead lighting can be adjusted by selecting the + or − buttons 706 and 707 on the display. The side table light 1 can be turned on or off using the buttons 709 and 710 on control bar 708. Additional control bars, if any, can be accessed by using the down arrow 711. A back button 712 navigates the user to the previous display. Selections can be made by touching the screen using a stylus, a finger, or the like. Three buttons are provided for controlling the display of the small touchpad 154.

Standard Touchpad

The standard touchpad 152 is a sophisticated operator interface designed for more enhanced presentation of information. The standard touchpad includes a 4 inch, 320.times.240 pixel personal data assistant (PDA)-style display and is capable of displaying video images as well as textual or icon based images. It is also capable of presenting web content in the manner of alerts or breaking news items. The standard touchpad 152 provides alarm and alert notification by means of color and sound, examples of which are:

Red-Flashing with buzzer—extreme alarm such as fire or intrusion detection;

Red with beeper—alarm such as system fault or pre-defined alarm condition (the two year old has entered the pool area);

Yellow with beeper—general alert such as hurricane warning or other weather or news advisory; and

Green with low level beeper—general information, such as clothes are ready from the dryer.

Being more sophisticated, the standard touchpad 152, which may be the only operator interface available, is not bound to controlling a single portion or subset of the BC system, and, instead, is capable of looking at the whole environment controlled by the BC system. It also is capable of configuring the system. An option for video display allows the standard touchpad 152 to present low-grade camera images such as, for example, from a camera positioned at the front door. A speaker and microphone can be included to provide an intercom with the video feature.

The standard touchpad 152 builds on the display of the small touchpad 154. The standard touchpad includes a display 731. A room selection bar 732 appears at the top of the display. The user may switch between rooms using the arrow button 733. Multiple control bars 735-738 also are displayed. Additional control bars can be accessed by using the down arrow 741. A back button 742 is provided for navigating back to the previous display window. Four keypad input buttons 744 are provided for immediate navigation to preset display windows and to manipulate the display window 731.

The standard touchpad 752 can be mounted onto a wall and hard wired. The standard touchpad 752 also can be used as a portable unit having a cradle for storing and re-charging the unit when not in use.

Portable Tablet

A portable tablet 150 can be used to communicate with the BC system provided that required connectivity options are available. The portable tablet 150 is used to present all aspects of the standard touchpad devices as well as more detailed configuration options. In addition, the portable tablet provides video and web browsing capabilities. The portable table may have a 12″ display and may be used in the distributed video network to control all televisions and video devices. As a result, a parent could use the portable tablet to flash a message on the children's TV—“its time for dinner.” The portable tablet may be implemented using a web pad.

The web pad interface includes an applications bar 756 that allows the user to switch between the various applications supported by the BC system. A tool bar 75 for selecting specific features, such as, for example, a particular appliance to control, is provided on the top of the display. A room selector arrow 753 also is provided. The portable table 150 is able to display a number of control bars (754, 755). A down arrow 758 provides selection of additional control bars associated with the appliance, if necessary. A back button 757 is also provided to move to the previous display screen.

Video Distribution Network

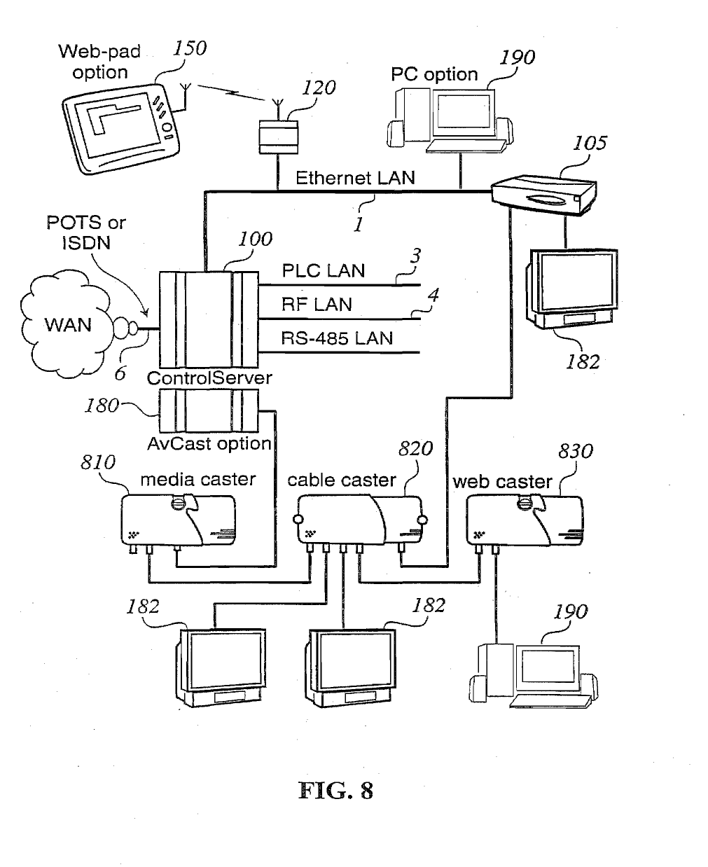

As shown in FIG. 8, a BC system includes a control server 100 connected to a number of primary networks including: an Ethernet LAN 1, a PLC LAN 3, an RF LAN 4, an RS485 LAN, a WAN (connected by a POTS or ISDN line), and a video distribution network 2. The video distribution network 2 includes an AvCast daughter board 180, a media caster module 810, a cable caster module 820, and a web caster module 830. The AvCast daughter board 180 plugs into a slot on the control server 100. The AvCast daughter board 180 can include the following interfaces: video out/VGA out, video in, dual USB—printer, keyboard/mouse interface, IR interface, and PCMCIA slot (optional). The video board provides video I/O as well as IR command transmission. A keyboard and mouse combination can be used with the video board through a USB or USB-to-RF interface (in the case of a wireless keyboard or mouse). A second USB connector can interface with printers, digital cameras, and other peripheral equipment. Functionally, the board accepts video input and digitizes the video for use by the rest of the BC system using the MPEG4 standard. The video board also provides video output as a TV channel for broadcast on connected televisions within the home.

The media caster module 810 is a digitally-tuned audio-video modulator with user selectable UHF or CATV channels. The media caster module 810 is individually addressable. The media caster module 810 allows signals from the control server 100 to be displayed on TVs 182 by converting the video output from the control server 100 to a TV channel. The resulting converted signal can be distributed to a number of TVs 182 using the cable caster module 820. Using the output TV channel, the control server 100 can broadcast video data, virtual control panels, security camera video output, messages, alarms, and control interfaces to any connected BC system interface.

The cable caster module 820 provides bi-directional signal-splitting with 6 dB of amplification to compensate for cable loss. The cable caster module 820 distributes a video signal feed to any connected TV 182 while providing enough amplification to ensure crisp TV pictures despite long cable runs and signal-splitting.

The web caster module 830 converts SVGA and audio inputs to a TV signal. The converted signal can be distributed to multiple TVs 182 and interfaces (e.g., 190 or 150) using the cable caster module 820. The web caster module 830 allows the data displayed on a PC screen 190 to be viewed on a TV 182. As a result, the TV 182 can be used as a second monitor for viewing, for example, web pages.

A gateway 105 offers broadband connection to a CATV system. The gateway 105 connects with the control server 100 through the high-speed Ethernet link 1 using, for example, a Cat5 cable. When used with the video distribution network 2, video signals can be routed through the media caster module 810 and cable caster module 820 to other TVs 182 using standard co-axial cable. In addition, the video signal from the gateway 105 can be fed directly into the cable caster module 820 for distribution by co-axial cable throughout a building. The gateway 105 provides a high-speed link enabling services such as, for example, video on demand, from the CATV connection. The high-speed link also provides a fast Internet connection for browser software running on the portable tablet 150 or the 90. Services, such as teleshopping, can be provided through the video distribution network 2, if supported by the cable service provider. The gateway 105 also provides a high-speed data link to the rest of the home network 1 supporting real-time video capability. The gateway 105 can be implemented as a standalone unit or as a plug-in module in the control server.

Smart Appliances

Smart appliances (e.g., 135) are network ready appliances that can be connected to the BC system without additional modification or interfaces. Once connected to the BC system, a smart appliance can be controlled by the control server 100. In addition, the smart appliance can be remotely controlled through use of a virtual control panel displayed on a BC system interface, such as a portable tablet 150. A smart appliance has either a communications module or a smart module that connects to the internal appliance controller to provide compatibility with the control server 100. The smart module and virtual control panel are described in detail in copending U.S. application Ser. No. 09/378,509, titled “DISTRIBUTED LIFE CYCLE DEVELOPMENT TOOL FOR CONTROLS” which is incorporated by reference in its entirety.

Retrofit Damper

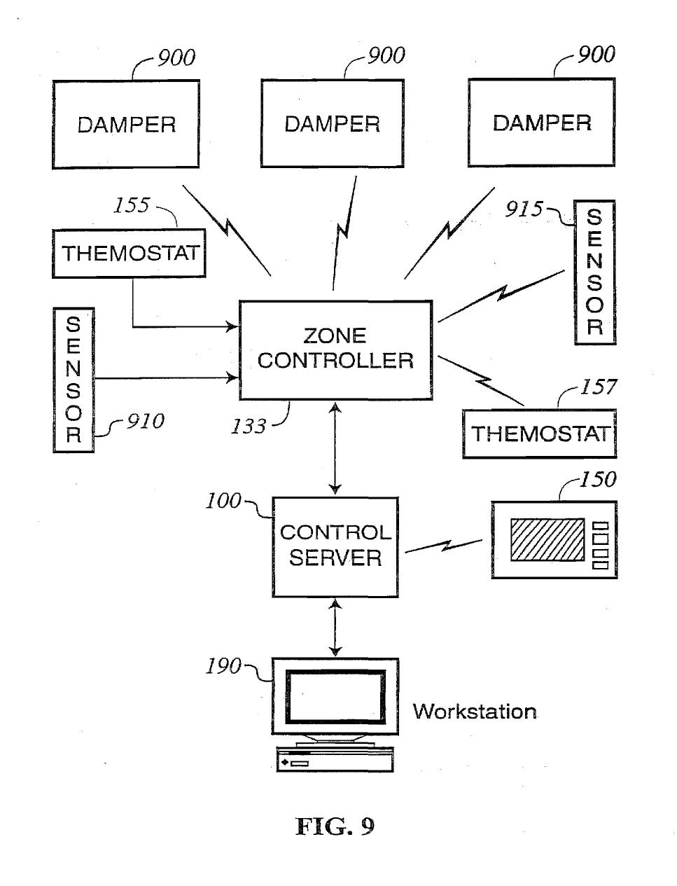

A wireless forced air damper for zoned HVAC control is shown in FIG. 9. The damper 900 is available in industry standard sizes to replace floor, wall, or ceiling registers. The damper 900 communicates with a smart HVAC zone controller 133 using wireless RF communications signals 901. A sensor 910 can be placed in the area serviced by the damper 900 to report local conditions to the zone controller 133. The sensor 910 communicates through the RF network 3, the PLC network 4, or through direct wiring to controller 133. Alternatively, the sensor 910 can be included in the damper 900 as described below. Additionally the sensor can be a wireless sensor 915. The zone controller 133 can be implemented as a stand-alone unit. Alternatively, the zone controller 133 can be supervised by the control server 100. If incorporated in the BC system, the zone controller 133 can be controlled by any of the BC system interfaces, such as the portable tablet 150. In addition, home manager software can be used to control zone controller 133 according to a number of predetermined modes of operation. Thermostats can be provided to provide user control of individual zones within a building. Existing wired thermostats 155 can be coupled to the zone controller to allow user control of the HVAC system. Additionally, wireless thermostats 157 can also be used. The wireless sensor 915 and thermostat 157 can be incorporated into a single unit.

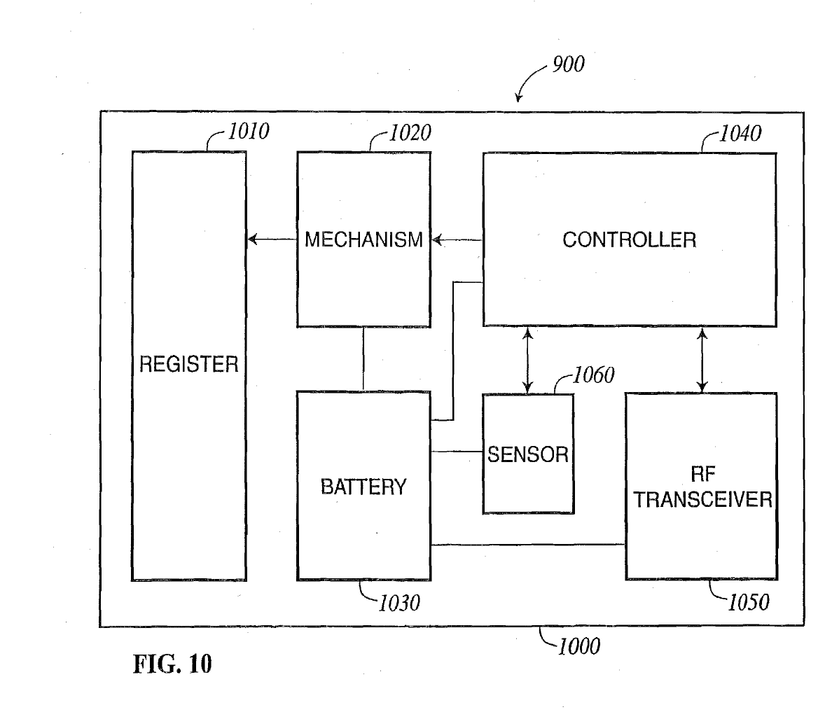

A block diagram of a damper 900 is shown in FIG. 10. The damper 900 includes a register 1010 for controlling air flow through the damper 900. An RF transceiver 1050 receives control signals 901 from the zone controller 133 and transmits status/sensed data to the zone controller 133. A power supply 1030, such as, for example, a battery or other self-contained power source, powers the damper's electrical components so that the damper is self-contained and does not require any additional wiring for power. A mechanism 1020, such as, for example, a solenoid, a spring, a shape memory wire, or a magnetic latching mechanism, is coupled to the register 1010. The mechanism 1020 actuates the register to allow air flow in response to a signal received from the controller 1040. A magnetic switch or latching mechanism having thousands of latching cycles may be used as the mechanism 1020 to reduce power consumption and to extend the operational life of the damper between 30 replacing/recharging of the power supply 1030. For example, the latching system can have one or two magnets. A capacitor can be charged from the battery using a trickle charge. In response to a control signal the capacitor can cause an induction, which actuates the magnet that holds register in one operation state. A second magnet or gravity may be used to return the register to its other operational state. A variable mechanism also may be used to control the register such that the register can be partially opened to regulate air flow (e.g., 100% open, 80% open, 50% open, and closed).

The controller 1040 can monitor the power supply 1030. When the power supply 1030 reaches a minimum charge threshold, the register 1010 is placed in an open state so that the register 1010 is left in the open position if power fails. In addition, the controller 1040 may notify the zone controller 133 that the power supply has reached a minimum threshold. Once notified, the zone controller 133 alerts the user that the power supply 1030 needs to be replaced/recharged. Alternatively, the zone controller 133 may poll the damper 900 to send a measurement of the power supply's remaining charge to the zone controller 133. Upon receipt of the measurement, the zone controller 133 performs the threshold analysis and alerts the user if necessary. A cover or door that is accessible from the room is provided to ease access to the power supply 1030.

When the fan unit on the air conditioner or the furnace is on, or when a preset condition occurs, the zone controller broadcasts a control signal to the controller 1040 to cause the mechanism to activate the register 1010. In addition, the zone controller 133 may selectively open or close dampers 900 based on a control program, a mode of operation, or upon a request from a user interface. Drain on the charge of the damper's power supply 1030 may be reduced by waiting until air flow has stopped before closing the register 1010 to limit the force needed to close the register 1010. A sensor 1060 may be connected to the controller 1040 to measure temperature at the damper 900. The measurement is supplied to the zone controller 133 as input to zone and comfort control software operating in the zone controller 133 or the control server 100.

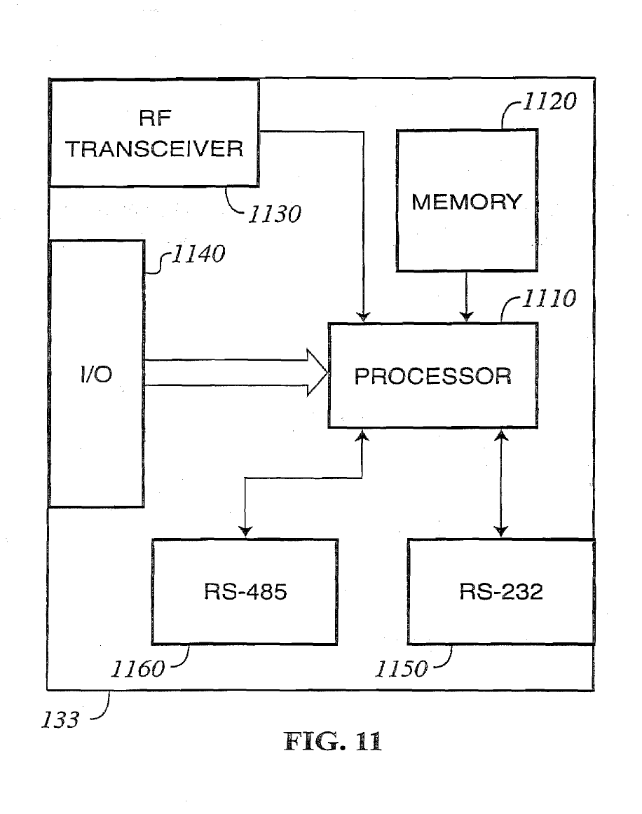

The zone controller 133 is shown in FIG. 11. The zone controller 133 can be implemented using a universal controller 110. The zone controller 133 includes a processor 1110 for controlling and monitoring the dampers 900. A memory 1120 is provided to store climate control software and for operation and identification of the dampers 900. An RF transceiver 1130 transmits control commands to and receives responses from the dampers in response to the commands. The dampers 900 are periodically polled by the zone controller 133 for status and sensor data. The data can be stored in the memory 1120 for analysis by the processor 1110 or the data may be transmitted to the control server 100 for storage and analysis. If no response is received from a damper 900 after being polled a number of times, the zone controller 133 notifies the user or control server 100 that the damper 900 is not responding and may need servicing. An optional I/O interface 1140 is provided for connection with external sensors 910. An RS-232 interface 1150 allows peripheral equipment, such as a handheld unit or a modem, to be connected to the zone controller 133. An RS-485 interface 1160 is provided to connect the zone controller 133 with the control server 100.

Each damper 900 is assigned a unique HVAC control ID number. The zone controller 133 uses the control ID number to identify a damper. Each installed damper 900 is dedicated to a single zone controller 133 and rejects interference from any other controllers, unless released by an authorized security code stored in the damper 900. Initial configuration of the dampers 900 can be accomplished according to one of the following methods.

According to a first method, zone controller 133 is placed in an initialization mode. Once the zone controller 133 has been placed in the initialization mode, the dampers 900 can be powered up one at a time. Upon powering up, a damper 900 broadcasts a message with the control ID to the zone controller 133. Configuration software in the zone controller 133 acknowledges the received broadcast message, stores the control ID, and prompts the user to identify the location of the damper. After the user enters the location, the zone controller 133 awaits receipt of the next initialization message and repeats the process until the locations of all dampers 900 are identified.

According to another method, barcodes can be used to configure the dampers 900 upon installation. When the damper is installed, a barcode on the damper 900 is scanned using a handheld device with a barcode reader. The barcode encodes the control ID for the damper 900. After reading the barcode, the handheld device prompts the installer to enter the location of the damper 900. The handheld device then associates the control ID with the entered location and stores this information in a table. Alternatively, barcodes identifying predetermined locations are placed in corresponding slots that accommodate the dampers 900. The installer scans the barcode in a slot using the handheld device. The installer then scans a barcode on the damper to read the damper's control ID and associates the damper with the location. After installation of the dampers, the damper control ID and the location data are downloaded to the zone controller 133 by connecting the handheld device to a port on the zone control 133.

According to another method, a barcode identifying the damper's control ID number can be peeled off the damper and placed on a location sheet. The sheet is scanned to determine a damper's control ID number and location. Once scanned, the data is downloaded to the zone controller 133.

After configuration of the dampers, according to any of the methods described above, the zone controller 133 controls the damper units 900 through RF control signals according to the instructions of the zone controller's operational programming. The zone controller 133 can broadcast control messages that are addressed to all dampers, to a set of dampers, or to a specific damper using the control ID numbers.

The above-described system is not limited to dampers. The control system could be applied to other flow control devices, such as hydronic systems using, for example, a valve instead of a register. Although the actuation devices and flow control mechanisms would be specific to the environment, the control circuitry and operation would be substantially the same.

Home Manager Software

The home manager software incorporates a number of fundamental modes of operation. Six exemplary modes are: a stay mode, an away mode, a bedtime mode, a sleep mode, a vacation mode, a wake-up mode, and a custom mode. The stay mode is configured to operate when the home is occupied. In this mode, certain aspects of the home, such as comfort control, are set automatically by the home manager. Other aspects, such as lighting scenes, are independent of the mode and are set either by the occupant or based on time of day occurrences.

The away mode implies that the home is occupied but no one currently is at home. When operating in the away mode, the BC system can override other programming, such as, for example, lighting control, to simulate occupancy and to arm the security system. During operation in the away mode, other system operations, such as energy saving control, can conserve energy by cutting back on hot water or comfort settings.

A bedtime mode (not to be confused with a sleep mode described below) can be incorporated in homes that have children. The bedtime mode is used when the children have gone to bed but there are still one or more adults awake in the home. Bedtime mode activates certain monitoring systems, such as, for example, child monitoring, checking to make sure certain televisions and other entertainment devices are off, and alerting the adults if certain lights come on (e.g., the children's rooms or bathrooms). Using this mode, parents can monitor sleeping children or be alerted when children wake up.

Sleep mode is used to put the house to sleep. While in sleep mode, the BC system arms the security system, and ensures that all doors are closed and locked, all lights and appliances are off, and that comfort settings are altered appropriately.

Vacation mode provides an enhanced state of security when a family is away from the home for an extended period of time. In this mode, lighting and entertainment systems may be used to simulate occupancy. Energy hungry systems, such as, for example, comfort control and hot water, may be reduced to minimum settings. Appliances may be monitored for unnatural activity, such as, for example, activation of the coffee pot (which normally would not switch on in the morning if the family were on vacation). However, the vacation mode can make allowances for house sitters who periodically bring in the mail or check on the house.

Wake-up mode is a choreographed schedule of events that happens as the house leaves sleep mode and enters stay mode. A number of timed events take place in the wakeup mode that can be customized for any particular residence. For example, prior to the alarm clock going off, comfort settings can be altered. If an HVAC zoning system is in place, the comfort settings can be adjusted in bedrooms and bathrooms first. Wake-up mode then increases the setting for the hot water heater, turns on the coffee pot, and adjusts other home systems in preparation for a family getting out of bed. A typical wake-up schedule would include: determine wake-up time based on day and weather, increase hot water temperature, increase temperature in bathrooms, shut off electric blankets, turn on the coffee pot, ramp up lights to simulate sunrise, activate wake-up alarm, turn on televisions for news, adjust comfort control for whole house. This list is exemplary and not comprehensive as any particular residence has a unique sequence of events. Other features can be programmed into the mode as desired by either the user or the service provider.

Custom modes also may be provided these modes may be programmed by the user, downloaded from a service provider over the Internet, or field programmed by a service provider technician on site.

There are a number of hidden modes that are invoked by features within the home manager. An example of a hidden mode is the fire mode. If a fire is detected by the security system, lights are adjusted to aid exit, doors are unlocked, gas to the house is shut off, the HVAC systems are shut down, and emergency numbers are called. Other hidden modes include: distress (robbery), medical emergency, and appliance failure

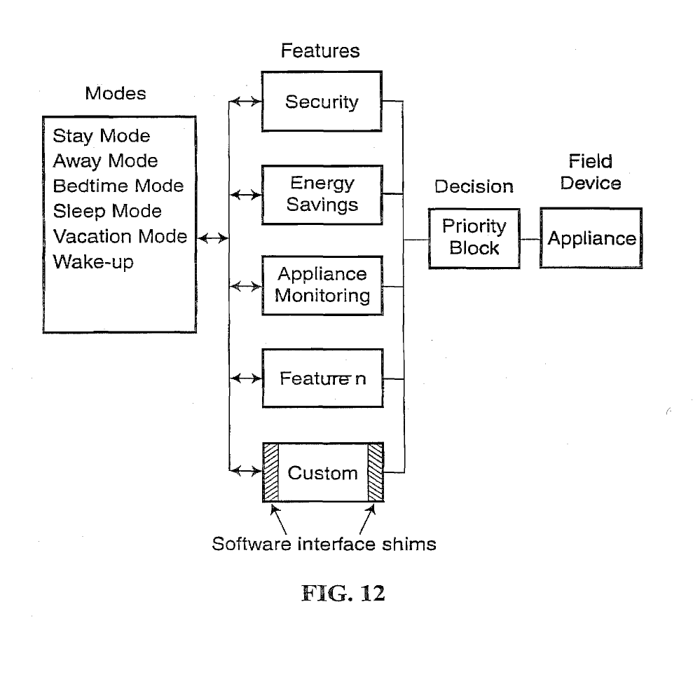

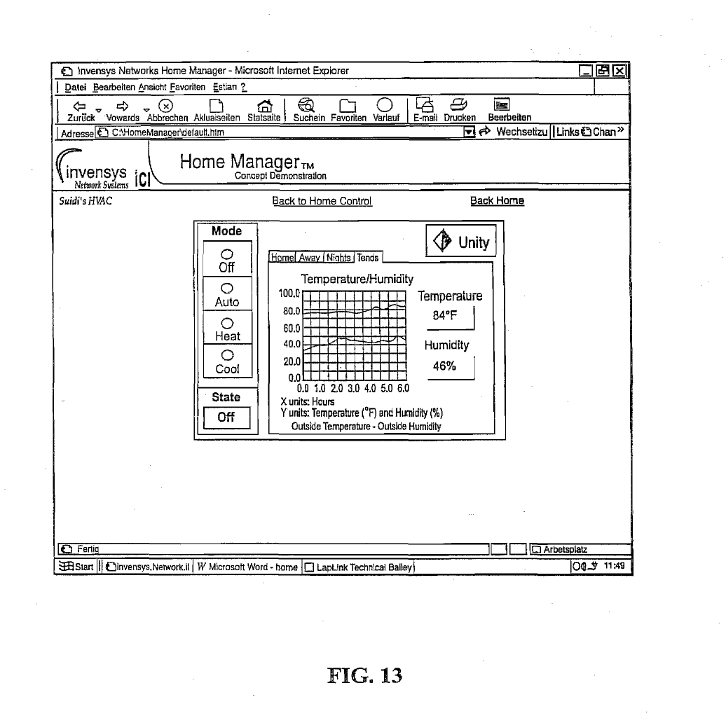

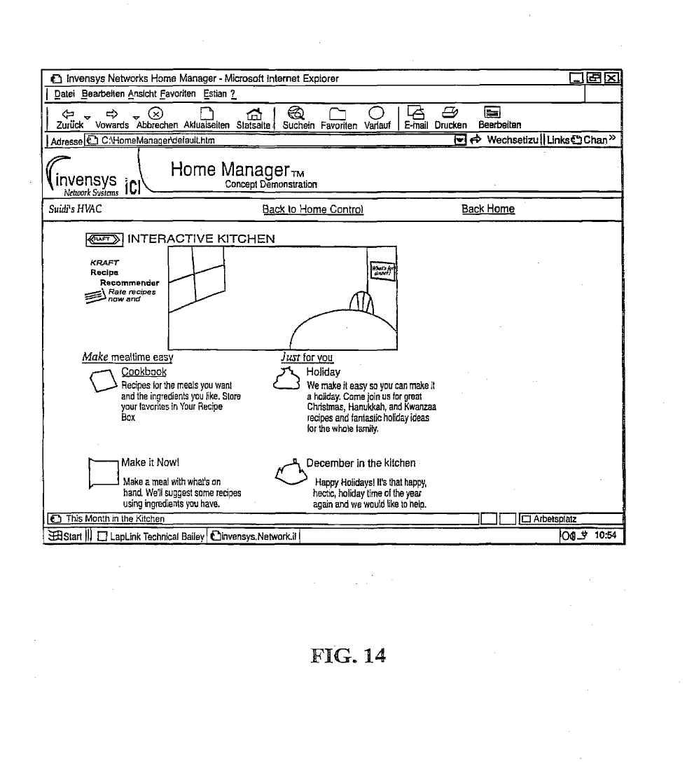

Architecturally, each device connected to the BC system subscribes to the various features offered in the house manager modes through priority blocks. Each feature responding to a mode has an associated priority setting, for example, a security feature responding to a fire mode has a higher priority level than a bedtime mode setting. FIG. 12 shows the relative positioning of the modes, the various features running on the system, the prioritization of each feature, and control of the field device. Features shown as custom may require additional programming to interface to the home management software.

Each feature also has an associated set of software functionality based on the hardware components available. The BC system automatically functions as described once the hardware is recognized by the BC system.

Enhanced security beyond that provided by a conventional security system is provided by the home manager. The enhanced security feature may supplement a conventional security system present in the home that is connected to the control server 100. Settings available in the enhanced security system include: armed/away mode, armed/stay mode, un-armed, system fault, medical emergency, police emergency, and fire emergency.

The settings for the security system relate to home manager modes in the following way. Both vacation mode and away mode invoke the away setting in the security panel. Both the armed/home and un-armed settings relate to the stay mode for the home manager. Although the armed/home setting does not relate directly to a specific mode, it can be set either by the existing security system or by the home manager on an individual basis.

Appliance Maintenance

Appliance maintenance allows for remote access of appliances within the home. Appliances can include, for example, any kitchen or laundry appliance, water heater, HVAC system, lighting, audio/visual, sprinkler, or comfort control. Connectivity to each appliance is provided by a telephone modem or a broadband connection to the control server, or the like. The control server 100 acts as the interface to the appliances and serves as a firewall to prevent unwanted tampering. All appliance control functions available within the home are allowed from outside of the home provided that the user is authorized to do so. In the event that a catastrophic failure is detected, a service provider can shut-off gas or water to the house to prevent an explosion or water damage.

Some appliances are capable of a certain amount of self-diagnosis, such as detecting a clogged filter. Under these conditions, the appliances can prompt the user to initiate repairs by displaying a message on a local user interface. In other instances, the appliance must be diagnosed either remotely or by a service provider on site. The control server's role in appliance diagnosis is to provide access to data by a remote site and to provide any necessary service prompts locally. The service provider may shut off the appliance if continued operation would damage the appliance.

Enhanced Comfort

Enhanced comfort control involves any aspect of home automation that automatically improves personal comfort. A number of devices, when connected to the control server 100, can be incorporated into the enhanced comfort feature. Examples of such devices include HVAC control, programmable thermostats, a zone control system, ceiling fans, air filtering, humidity control, and automatic blinds.

HVAC control encompasses the broadest aspect of comfort control. HVAC control also can be impacted by an energy management or an enhanced security feature, if available. Programmable communicating thermostats provide the greatest impact on the ability to manage comfort in the home. Fundamentally, the home manager communicates with the thermostat and allows the homeowner to program and configure the thermostat. In addition, other features within the home manager are able to override or alter the actions of the thermostat if needed, for example, when the enhanced security system shuts down the airblower in case of a fire. Under the energy management feature, the thermostat setting can be adjusted to shed load during high tariff conditions or when the home is unoccupied.

Zoning control is a feature that can provide benefit to virtually every home. There are always instances where one area of the home is hotter or colder than another area. A zoning system uses temperature sensors and variable dampers to adjust the temperature of each zone independently. The home manager supports two forms of zoning: hardwired and wireless.

A hardwired zoning system involves dampers installed inside ductwork communicating to the control server through a central HVAC zoning package, or directly through PLC communications. Similarly, the temperature sensors are connected to the control server 100 either through PLC or through the zoning package.

In the case of a wireless zoning system, RF communications are used to communicate to all temperature sensors and dampers. In this instance, the retrofit damper described above can be incorporated.

Main HVAC control can be provided through direct connection from the control server 100 to the HVAC zone controller unit 133 or to a communicating thermostat, which in turn controls the packaged unit. If the control server 100 is taken off-line for some reason, the HVAC zone controller 133 or communicating thermostat can revert to a conventional operation mode.

Other devices, such as, for example, ceiling fans, humidifier/de-humidifiers, air filters, adjustable skylights, and automatic blinds can respond to an algorithm for comfort control implemented in the HVAC controller 110 or the control server 100.

Energy Savings

The primary method for achieving energy savings is to reduce settings or turn off large energy consuming appliances during non-critical times or peak tariff times. The away mode controlled by the home manager system can lower thermostats, reduce temperature of the hot water heater, coordinate HVAC and appliances based on peak tariff conditions by adjusting thermostats to appropriate extremes of the comfort zone, restricting use of appliances to off-peak times, using automatic blinds and skylights to reduce HVAC demand, and synchronizing HVAC and hot water heater control with the sleep mode by cutting back temperatures during sleep time and bringing them back up as part of the wake-up cycle.

Home Automation

The home automation feature consists of a variety of modes that can be invoked from the stay mode, the bedtime mode, or the sleep mode. This feature consists of settings for groups of devices associated with certain activities. There are a number of default modes plus a set of user defined modes provided by this feature referred to as activity modes, Default activity modes include: television, reading, dinner, formal dinner, and party. The homeowner can add activity modes, such as, for example, gaming, for playing cards, or night swim, to turn on back yard lights.

BC Systems Meter Network

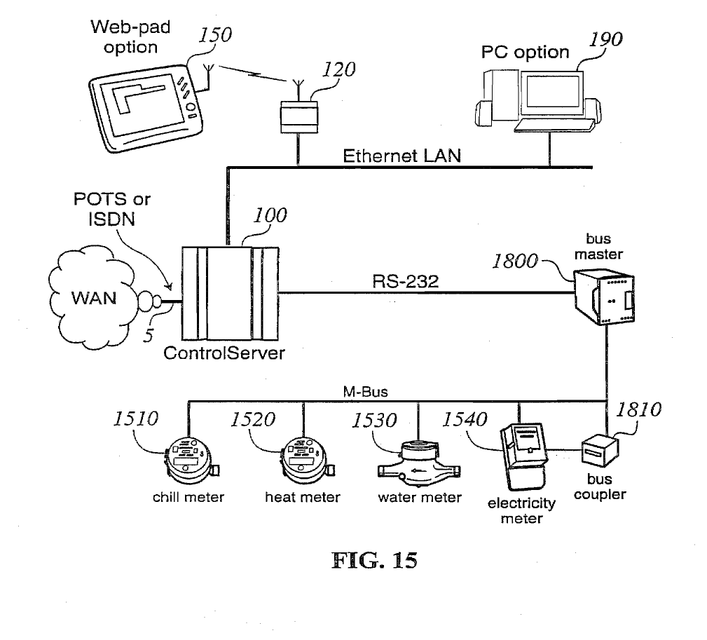

The meter network and its link to the control server is explained with reference to FIG. 15. Water meter 1510 and heat meters (1520,1530) are connected with a bus 1501 output that allows the meters to be networked via CatS cable to a bus master unit 1500. The bus master unit 1500 converts the bus signals to a format readable by the control server 100. The electricity meter 1540 has a pulse output that requires an additional bus coupler 1510. The bus coupler 1510 accumulates the pulses and allows connection to the bus 1501. Each coupler has pulse inputs for up to 4 meters. The bus 1501 has an open protocol such that any product that conforms to bus standards can be connected to the network.

Ideally the bus master unit 1500 is located in the same position within the house as the control server 100 and connects to the control server 100 through one of the control server's RS-232 ports.

The control server 100 allows each meter to be read by an authorized external data collection service. As a result, a wide variety of monitoring services can be offered, such as, for example, data collection, data analysis, and payment. Such services benefit the end-user through improved visibility of energy usage leading to better energy management. The home manager software can display energy consumption data and trends and to give tips for reducing consumption.

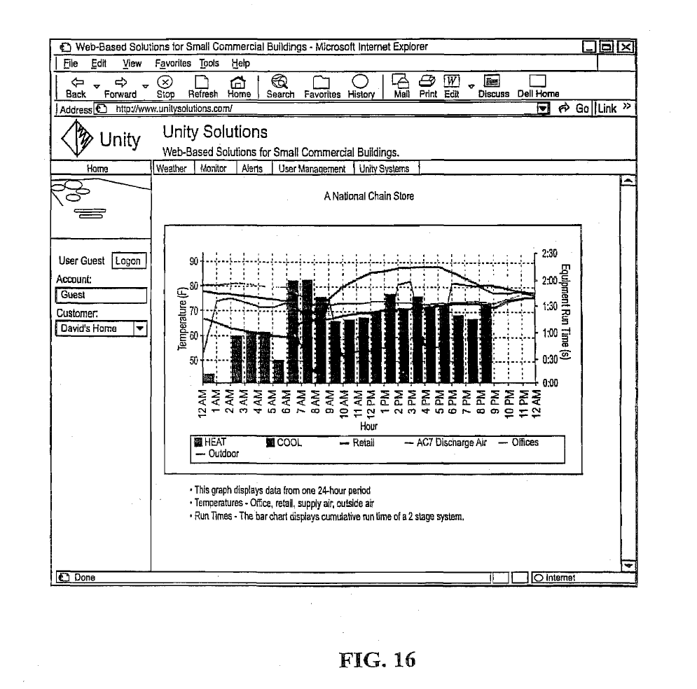

Energy DataVision (EDV) is an online data display package that enables energy users to monitor energy usage patterns via the web. IMServ's data collection service arm remotely interrogates metes to access meter reads. Each meter has an identification number assigned to it. The monitoring services is given an access code to log into the control server 100 and use the EDV system to create a variety of reports regarding energy usage for the building. EDV can graph usage trends from month-to-month, day-to-day, date-to-date, hour-to-hour. An example of an EDV screen shot is shown in FIG. 16.

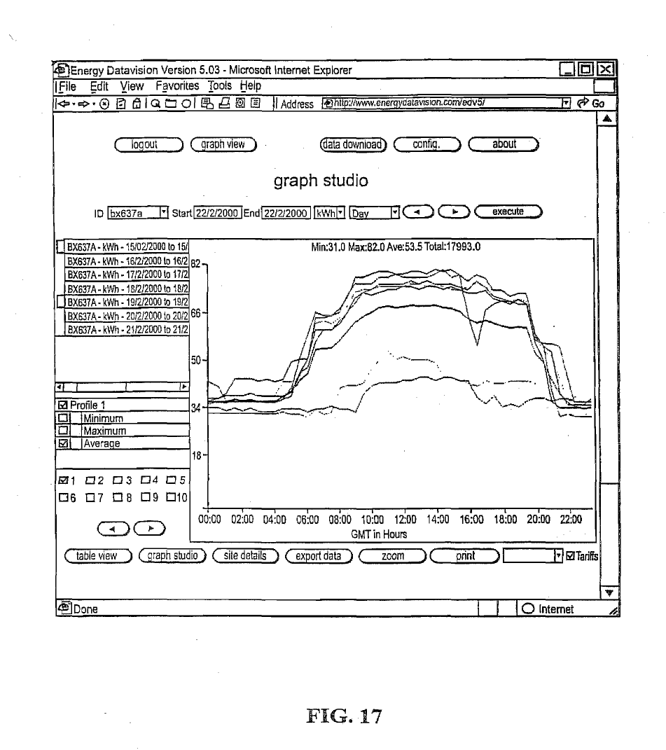

Commercial diagnosis analysis is shown in FIG. 17.

Central Locking and Door Access System

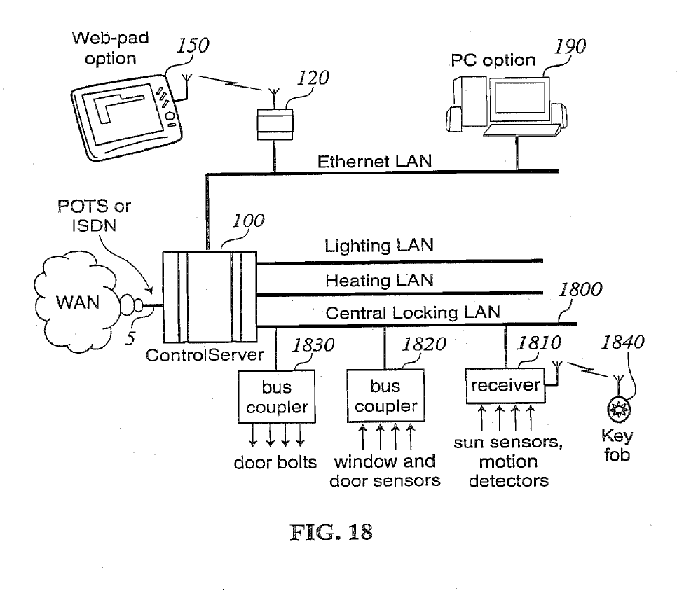

The central locking system, shown in FIG. 18, includes an RF key fob 1040, a receiver 1810, a motorized door bolt, and sensors to detect an open/closed door, door bolt position, and open/closed windows. A bus coupler 1830 is provided for connection to the motorized door bolt. The motorized door bolt is activated and deactivated using the key fob 1840. The key fob 1840 transmits a lock signal and an unlock signal to the RF receiver 1810. The RF receiver relays the signals to the control server 100 to control one or more motorized door bolts. The motorized door bolts also can be controlled using other BC system interfaces, such as, for example, a portable tablet 150 (through control module 120), a PC interface 190, or through the Internet portal 5. A second bus coupler 1820 provides inputs from the widow and door sensors to the control server 100 indicating an open/closed state of the doors and windows.

The control server 100 can interface with an existing door access system by using one of the bus coupler outputs to trigger the door controller (i.e., the opening/closing mechanism). The central locking system allows the user to check that all windows and doors are in the correct position before automatically locking them. The same key fob 1840 can be used with the door access system to open the common access door either from inside or outside the building. This reduces the number of keys that need to be used in any one location.

The key fob technology ensures security by appropriate coding. More than one key fob can be accommodated to allow each family member to have his or her own key. On activating the close function from the key fob, the control server 100 checks that all doors and windows connected to the system are closed. A warning is given (e.g., by continually flashing the door/hall lights) if the all sensors do not detect a closed position. If all doors and windows are closed, the system activates the locks. After the locks have been activated another check is performed and if all doors have successfully locked and indication is given (e.g., flashing the door/hall light once).

In the event of a power failure, the doors remain secure but in the event of a fire or other emergency they are easily opened from the inside and do not impede an escape route.

The home manager software for the control server 100 can include the central locking features.

House Security System

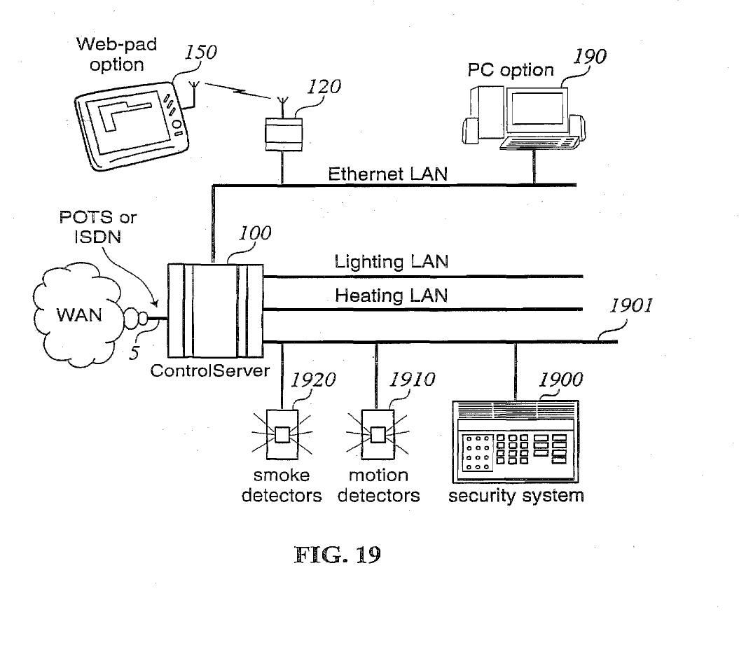

A home security network is shown in FIG. 19. The required sensors can be hardwired to an existing electronic security system 1900. The existing security system 1900 is linked into the control server 100 through a serial link 1901. Alternatively, RF controlled motion detectors 1900 and smoke detectors 1920 can send signals to the control server 100 for analysis. The control server 100 provides telephone connection and web services that are need for the security system. The status of the security system can be monitored by a remote server using the Internet portal 5, dedicated ISDN, DSL, or POTS service, or any of the home interfaces, such as portable tablet 150 or PC interface 190.

The existing network can be extended by adding the sensors to the appropriate LAN. In this case, the home manager software can be customized to provide specific system features tailored to the location. The security system using the control server 100 can perform all standard functions such as intruder alarm (through door and window switches or motion detectors) and alarm generation (either locally or remotely).

Lighting System

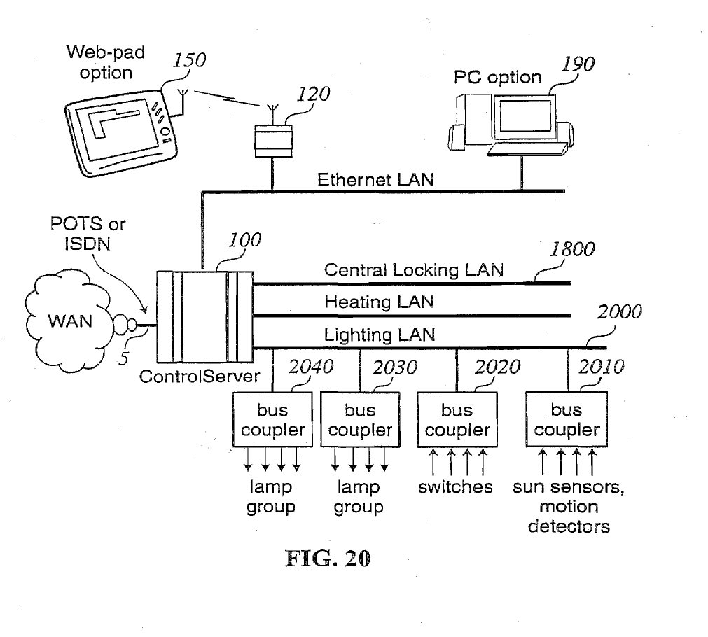

A lighting network for use with the BC system is shown in FIG. 20. The lighting network comprises a lighting system LAN 2000. A number of bus couplers are connected to the lighting system LAN 2000. Each bus coupler is directly wired to a number of lamps, switches, or sensors. For example, bus couplers 2030 and 2040 are each dedicated to a lamp group, bus coupler 2020 receives signals from a number of switches, and bus couple 2010 receives inputs from sensors (e.g., motion and sun detectors). The bus couplers can be mounted in an electrical distribution box with the loads and inputs connected through a conventional mains cable.

The lighting system LAN 2000 can be implemented using an EIB or other LAN. The EIB LAN uses a bus converter to connect the LAN to the control server 100 using an available RS-232 port of the control server 100. The lighting network can operate even if the control server 100 has a failure. However, interaction with other systems, such as central locking or security, would not be available. A networked lighting system offers flexibility that allows the relationship between switch and lamp be changed simply by re-configuring the system. In addition, lamps, switches, and sensors attached to the lighting LAN 2000 can be shared and controlled by other systems connected to the control server 100. For example, the central locking system can put the house into standby mode when closed ensuring that no lights are left on when the house is empty. A light sensor can be used to detect sun rise and sun set so that the control server 100 can control the lights in a way to simulate occupation. Optionally, motion sensors can be used to switch lights off when a room is unoccupied or to switch them on when someone enters.

The lights also can be controlled using any of the BC system interfaces, such as, for example, PC 190, portable tablet 150 or through a remote interface connected through Internet portal 5.

Temperature Control System

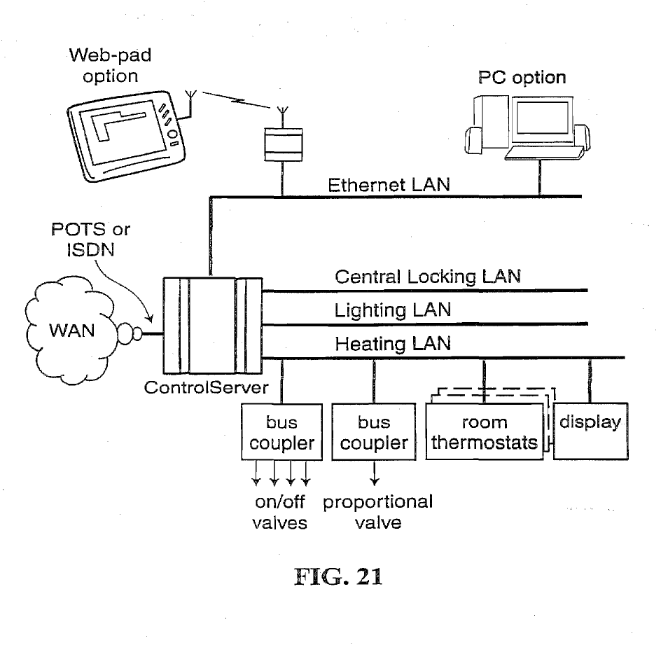

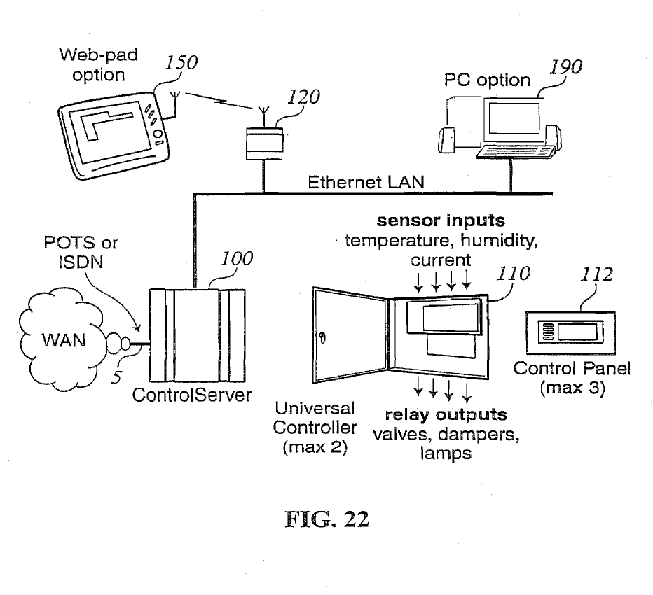

A temperature control system is shown in FIG. 21. A heating LAN (e.g., an EIB LAN) can be used to control the temperature of rooms and provide zone control. The heating LAN connects the control server 100 to control valves, to room thermostats, and to room displays through a number of bus connectors. Alternatively, the heating LAN can be controlled by a universal controller 110 or a zone control 133 under supervision of the control server 100 (as described in the next section). As shown in FIG. 21, the control server communicates with room thermostats through the heating LAN while bus couplers drive on/off valves, proportional valves, and dampers. Alternatively, RF controlled dampers and thermostats can be used as described above with regard to FIGS. 9-11.

Linking the heating LAN to the control server 100 gives access to the other systems so that, for example, the central locking system could put the heating system into standby mode when the house is locked. The window sensors used either by a central locking system or a security system can be used by the heating system to turn off room radiators when a window in the corresponding room is open for longer than a certain period of time.

A network of thermostats and valves allows a comprehensive software user interface offered by the home manager to effectuate zone and profile control.

Zone and Profile Temperature Control System

The universal controller 110 offers a very flexible temperature control system that can be linked to the control server 100. An LCD touch-pad 112 gives the user access to the system for changing temperatures, times, and other system management functions. The universal controller 10 is designed for mounting in an electrical distribution box. The box can be placed adjacent to the control server 100 or close to the valve/damper array for the heating system. The universal controller 110 links to the control server 100 using an RS-485 network interface.

The control panel 112 is wall mounted and connects to the universal controller through three sets of twisted-pair wires. Each universal controller 110 has up to 16 configurable analogue/digital inputs and twelve configurable relays output pairs. To add additional inputs and outputs a second universal controller 110 can be networked into the system. Up to three control panels can be placed at different positions around the home. An additional power supply allows two more control panels to be added if desired.

Once installed, the universal controller 110 needs to be configured. Configuration should be carried out by trained personnel using a PC running configuration software. The temperature control system allows up to 16 zones for either heating or cooling systems or 10 zones for combined heating and cooling. For example, each room in the house could be configured as a single zone. A temperature sensor in each room allows the user to set the required temperature and control the temperature controlling a valve/register to the room radiator feed or air damper. For combined heating and cooling systems, a valve is added to control the fan coil feed.

Each zone is programmed with a profile of temperatures by day of the week and time of day. As a result, only those rooms, which are normally occupied at particular times or days need be heated or cooled. The control panel 112 allows the user to over-ride these profiles at a given time. The profiles can also be over-ridden by the control server 100 so that, for example, the heating system can be turned down if the central locking system reports that the house is locked and unoccupied. An outside air temperature sensor can be added to allow improved temperature control algorithms that account for ambient weather and temperature conditions.

The universal controller 110 can interface directly with a fire alarm system or individual smoke detectors allowing the universal controller to close all dampers and turn of the boiler and air circulating fan upon detection of a fire.

A wide variety of other sensors can be added to complement the functions offered by the system. For example, CO, CO2, flammable gas sensors could also be incorporated for home safety.

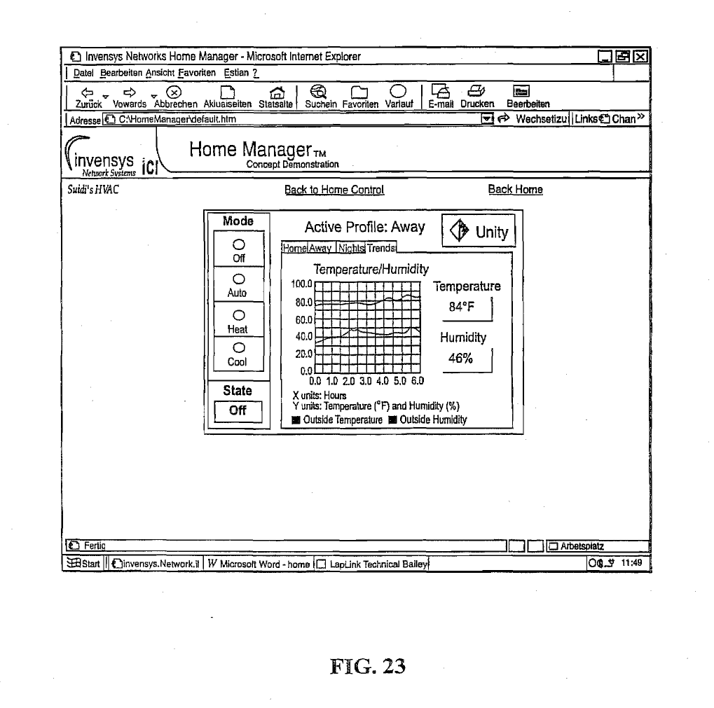

The universal controller 110 has a monitor function that allows current status of all connected devices to be viewed. The monitor function can be made available to the control server 100 and to any user interface (e.g., 150 or 190) connected to the control server 100, including a telephone connection. The home manager software can deliver a java file that is displayed using browser software on a local PC 190, or over a remote connection using Internet portal 5. An example of a screen shot for control of the HVAC is shown in FIG. 23.

Networked Appliances

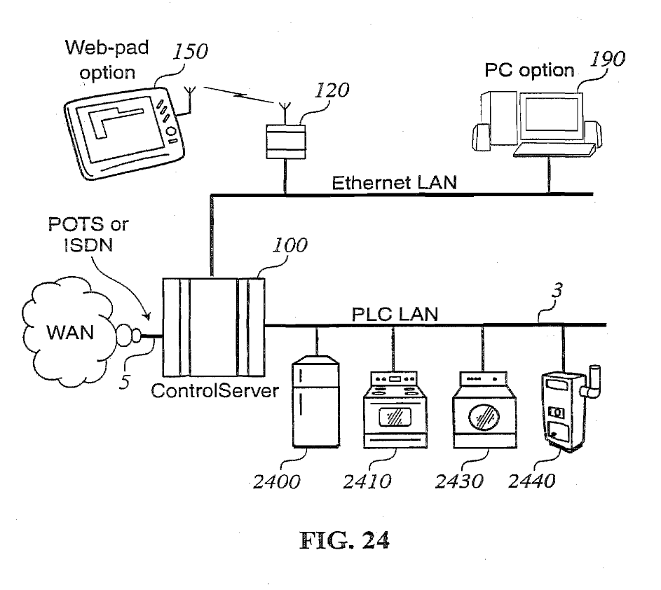

An appliance network is shown in FIG. 24. The networked appliances can communicate with the control server 100 using PLC LAN 3. An appliance is networked simply by plugging the appliance into the wall outlet connecting the appliance to the control server 100 through the PLC network. As a result, no additional wiring or re-configuring is necessary each time an appliance is installed or reconfigured.

Connecting appliances to the control server 100 provides a number of benefits due to the sharing of data with other networked devices and the connection to external service monitoring companies through a phone line or Internet connection.

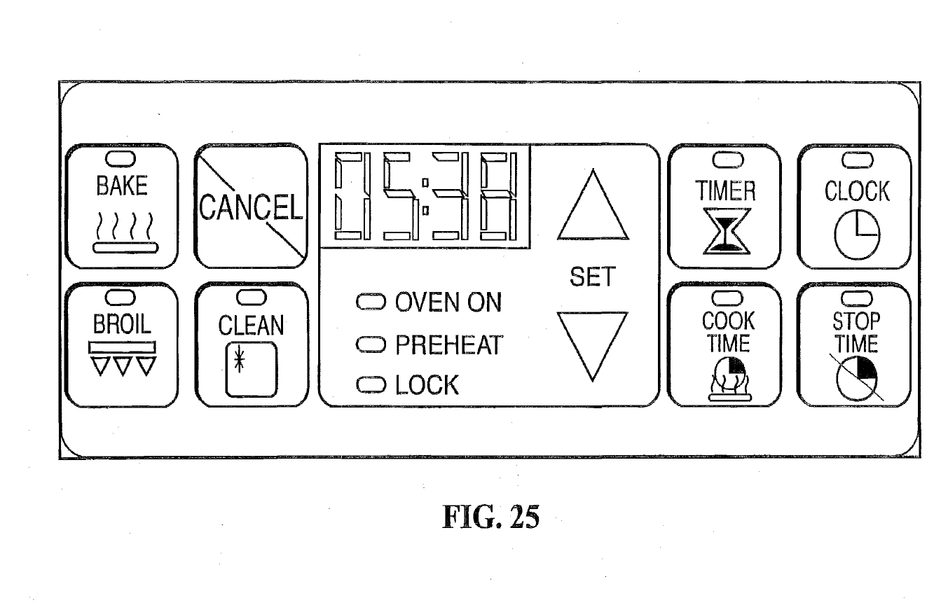

The home manager software is able to display virtual control panels for each appliance as shown in FIG. 25. As a result, the appliance can be controlled remotely under the supervision and monitoring of a portable web pad 150 within the home, or from a remote location using the Internet portal 5. When combined with the AvCast option, the home manager pages can be displayed on the TV screens in the home. As a result, during advertisements, for example the user can switch to the oven channel to see how the roast is doing. The appliance's virtual control panel has the same appearance as the physical controls panel on the appliance.

Service companies can offer remote monitoring facilities to reduce the cost of repairs enabling them to offer extended warranty coverage for all such connected appliances.

Refrigeration Monitoring Unit

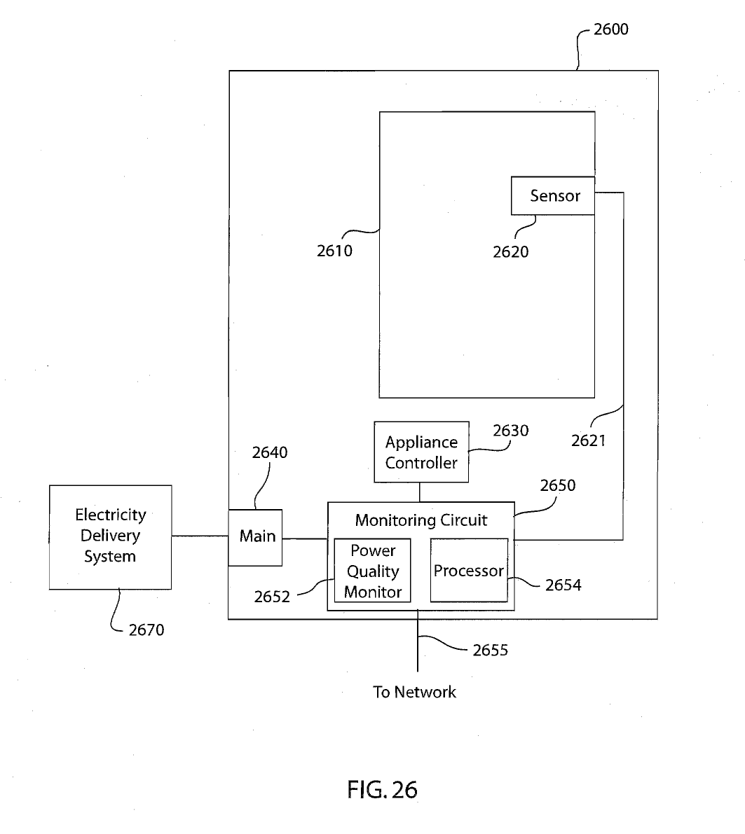

FIG. 26 shows a refrigeration monitoring system. As shown in FIG. 26, a refrigeration appliance 2600, such as, for example, a refrigerator or freezer, can be retrofit or designed to include a system to monitor for food properties, such as, for example, spoilage, and to alert the operator of the refrigeration appliance so that appropriate action can be taken, if necessary.

The refrigeration appliance 2600 can include a monitoring circuit 2650 to allow the appliance to communicate with a remotely located computer, such as, for example, a control server 100, a gateway, or a building monitoring service. The monitoring circuit 2650 can be contained within the appliance 2600, as shown, or can be an external retrofit device. The monitoring circuit 2650 includes an alternative power source, such as a battery, a capacitor or any other suitable form of backup power that allows the circuit to operate in the event of a power failure or outage at the location of the refrigeration appliance 2600. An LED indicator can be included on the outside of the circuit 2650 to indicate a battery low condition. The monitoring circuit 2650 also can monitor the power level or backup power supply failure of the battery or the condition of the back-up power supply and signal a monitoring service or user when the battery or backup power supply should be changed.

The refrigeration appliance 2600 includes at least one compartment 2610, such as, for example, a freezer or a refrigeration compartment. A sensor 2620 can be included or retrofitted to the refrigeration appliance 2600. The sensor 2620 can be retrofitted by drilling a hole in the appliance 2600 to allow placement of the sensor 2620, such as a thermistor or another temperature-sensing device, inside the compartment 2610. A special seal or ring (sized to the hole and including insulation characteristics) can be inserted in the hole to act as an anchor for the sensor 2620. A cable or interface connection 2621 couples the sensor 2620 to the monitoring circuit 2650. The monitoring circuit 2650 includes a serial or other port to accept the interface connection 2621. The sensor 2620 provides data on the sensed condition within the compartment 2610, for example, temperature, to allow the monitoring circuit 2650 to monitor conditions within the refrigeration appliance 2600.

The monitoring circuit 2650 includes a power quality monitor 2652 to sense the power quality of the electricity supply and a processor 2654 to process the sensed condition and perform analysis of the data. In one example, the processor 2654 can be programmed to calculate the speed at which temperature is rising in the appliance to determine how long it will be until food spoilage occurs. This information can then be provided to a user or the monitoring unit can take appropriate action, as will be described.

The monitoring circuit 2650 is installed by connecting the monitoring circuit 2650 to the main power supply 2640 of the appliance controller 2630, which in turn is connected to the electricity delivery system 2670. During normal operation, the monitoring circuit 2650 can use PLC communication to provide data about the refrigeration appliance. Alternatively, other communications interfaces can be used. The monitoring circuit 2650 also may include a communications circuit implemented by a modem or a RF communication device. In the case of a modem, a phone jack and a communications port 2655 are provided. In the event of a power failure, the monitoring circuit 2650 can alert a user or monitoring service that power is out. The monitoring circuit 2650 also may dial a repair service if it is determined that there is a malfunction within the refrigeration appliance 2600.

The processor 2654 included in the monitoring circuit 2650 also monitors the temperature within compartment 2610 and provides an estimation of how long until food spoilage occurs. The estimate can be updated if sensed conditions within the compartment 2610 change. The monitoring circuit 2650 also can perform other analyses. For example, if it is determined that the compressor is on longer than expected, combined with a rising temperature in the compartment, the monitoring circuit 2650 may determine that a door open condition has occurred and may provide a message to the user or monitoring service of the open door condition.

In the embodiment of the monitoring circuit 2650 shown in FIG. 26, the monitoring circuit includes the power quality monitor 2652 that continuously monitors the incoming power from the electricity delivery system 2670 through the refrigeration appliance mains 2640. The monitoring circuit 2650 can thus determine the quality of power by one or more factors. As an example, the monitoring circuit 2650 can monitor and measure voltage levels on the electricity delivery system 2670, the frequency of the incoming power, or both. The monitoring circuit 2650 monitors one or both of the incoming power quality metrics and compares these metrics against a defined range or threshold value to determine whether an alarm condition exists. For example, the normal value for the voltage on the electricity delivery system 2670 is typically approximately 120 volts while the frequency is approximately 60 cycles per second. In the preferred embodiment of the invention, the monitoring circuit 2650 includes an upper and a lower threshold value for both the voltage and frequency on the electricity delivery system. As an example, the high voltage trigger threshold could be set at +20 volts or 140 volts and the low voltage trigger level could be set at −20 volts or 100 volts. If the voltage on the electricity delivery system 2670 either exceeds the high voltage threshold value or the low voltage threshold value, the monitoring circuit 26 will generate an alarm signal.

In addition to monitoring the voltage on the electricity delivery system 2670, the monitoring circuit 2650 also includes a low frequency threshold. As an example, if the frequency on the electricity delivery system 2670 drops below 59.8 cycles per second, the monitoring circuit 2650 would generate an alarm signal.

As illustrated in FIG. 26, the monitoring circuit is positioned between the electricity mains 2640 and the appliance controller 2630. In the preferred embodiment of the invention, if the monitoring circuit 2650 generates an alarm signal, as a result of any of a low voltage, high voltage or low frequency condition, the monitoring circuit 2650 interrupts the supply of electricity from the electricity mains 2640 to the appliance controller 2630. This disconnection prevents the appliance controller 2630 from operating the high resistive load devices within the refrigeration appliance 2600, such as a defrost heating coil or the compressor. In this manner, during low voltage or low frequency conditions, the monitoring circuit 2650 prevents or limits the operation of the refrigeration appliance 2600, thereby reducing the overall demand on the electricity delivery system 2670.

In addition to monitoring the power quality on the electricity delivery system 2670, the monitoring circuit 2650 receives input from a sensor 2620 positioned within the compartment 2610. Preferably, the sensor 2620 is a temperature sensor that detects the temperature within the compartment 2610. Since the monitoring circuit 2650 includes the processor 2654, the processor 2654 can be programmed to monitor the temperature within the compartment 2610 and calculate when food spoilage will occur following the interruption of electricity to the refrigeration appliance. It is contemplated that the processor within the monitoring circuit 26 will utilize conventional food industry temperature and time algorithms to calculate when food will become spoiled.

When the processor 2654 within the monitoring circuit 2650 determines that food spoilage will occur, the monitoring circuit 2650 will reconnect the appliance controller 2630 to the mains 2640 such that the appliance controller can operate the compressor contained within the refrigeration appliance 2600. In this manner, the monitoring circuit 2650, in combination with the appliance controller 2630, can disconnect the load elements of the refrigeration appliance 2600 from the electricity delivery system 2670 to aid in demand reduction while at the same time preventing food items contained within the compartment 2610 from spoiling. In addition to disconnecting the refrigeration appliance 2600 during periods of low voltage or low frequency, the power quality monitor 252 can also detect an excess of power on the delivery system. When the power quality monitor detects such an excess, the monitoring circuit 2650 can signal the appliance controller 2630 to engage resistive load elements contained within the refrigeration appliance, such as a heating element normally used to defrost the refrigerated enclosure. Activation of the resistive load elements upon detection of a high voltage on the electricity delivery system will aid in protecting the electricity grid from spikes, which normally will be corrected in seconds.

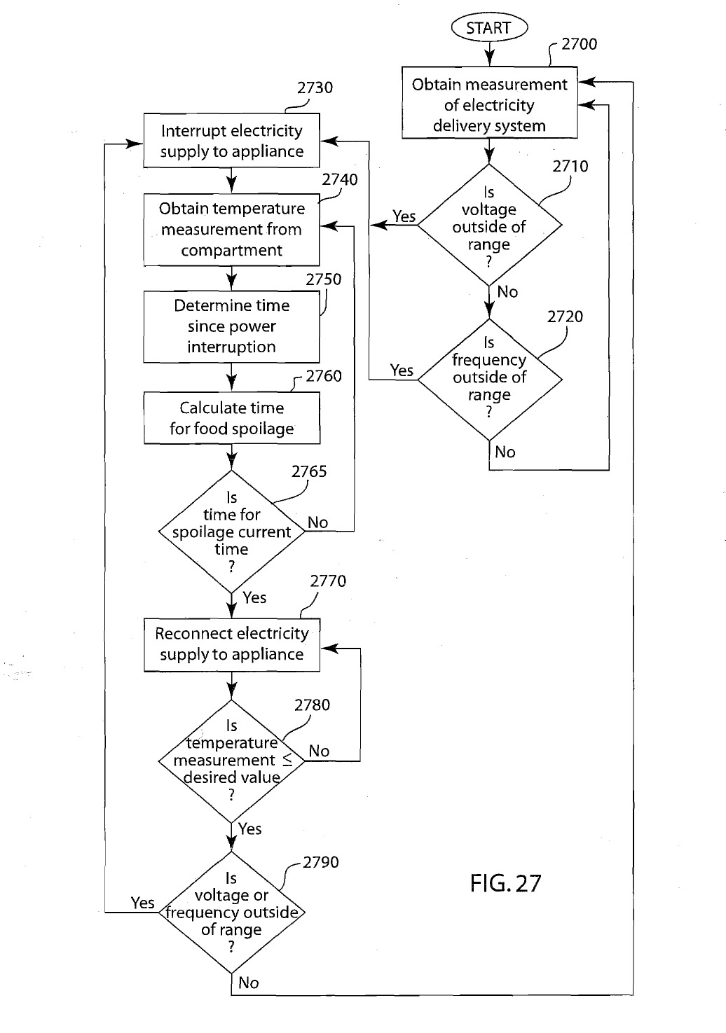

Referring now to FIG. 27, thereshown is a flowchart illustrating the operational steps performed by the monitoring circuit 2650 in accordance with the present invention. Initially, the monitoring circuit 2650 obtains a measurement of the power quality of the electricity delivery system, as illustrated in step 2700. As described previously, the monitoring circuit 2650 obtains a measurement of the power quality through the mains 2640, which is connected to the electricity delivery system 2670.

After the measurement has been taken, the monitoring circuit determines in steps 2710 and 2720 whether the voltage and/or frequency are out of acceptable ranges set by upper and lower thresholds. As described previously, the upper and lower thresholds for the voltage may be 100 and 140 volts, respectively, while the frequency thresholds may be 59.8 Hz and 60.2 Hz.

Although fixed upper and lower thresholds for the voltage are contemplated, it should be noted that the system could operate in a “learned” voltage environment in which the system determines the normal voltage at the installed location. The normal voltage for any location will be dictated by its distance from the substation and the line losses encountered in the distribution system. Once installed, the system will monitor and calculate a normal voltage for the location. Once the normal voltage has been determined, the system will set upper and lower threshold values based on a percentage of the normal voltage.

If the system determines in either step 2710 or 2720 that the power quality values are outside of acceptable ranges, the monitoring system immediately interrupts the supply of electricity to the refrigeration appliance, as shown in step 2730. Alternatively, if the frequency and voltage values remain within a desired range, the system returns back to step 2700 and continues to monitor the power quality on the electricity delivery system.

As described above, the monitoring circuit interrupts the supply of electricity to the appliance to prevent the appliance from drawing any additional voltage or current from the electricity delivery system. The immediate interruption of the electricity supply limits the demand on the electricity delivery system to prevent brownouts or other similar conditions. Preferably, the monitoring circuit 2650 will interrupt the supply of electricity to the refrigeration appliance within two or three cycles of identifying the alarm condition.

After the supply of electricity has been interrupted, the monitoring circuit 2650 obtains a temperature measurement from the compartment within the refrigeration appliance, as shown in step 2740. As described previously, the compartment includes a sensor 2620 that allows the monitoring circuit to determine the temperature within the compartment 2610.

After obtaining the temperature measurement, the monitoring circuit determines the amount of time that has passed since the power interruption, as shown in step 2750. Based upon the temperature and time measurements, the processor of the monitoring circuit calculates a predicted time for food spoilage within the cooled compartments, as shown in step 2760. As described previously, the processor within the monitoring circuit can use conventional food industry temperature and time algorithms to predict when food will spoil following the electricity interruption based upon the sensor readings from within the enclosed compartment.

After the monitoring circuit has calculated the time for food spoilage, the monitoring circuit determines in step 2765 whether the time for spoilage is equal to the current time. If the time for spoilage is not the present time, the system returns to step 2740 to obtain another temperature measurement from the compartment.

However, if the time for spoilage is close to the present time, the monitoring circuit reconnects the refrigeration appliance to the electricity supply, as shown in step 2770. The reconnection of the electricity supply to the appliance allows the appliance controller to reactivate the compressor to cool the temperature within the compartment and prevent food spoilage.

In step 2780, the monitoring circuit determines whether the temperature within the enclosed compartment has fallen beneath a desired value to prevent food spoilage. If the temperature has not fallen below the desired value, the system continues to connect the electricity supply to the appliance in step 2770.

However, if the temperature measurement is below the desired value, the system determines in step 2790 whether the voltage or frequency is outside of the threshold values, similar to the function performed in steps 2710 and 2720. If the voltage and/or frequency are outside of the desired range, the system returns to step 2730 to interrupt the electricity supply to the appliance. However, if the voltage and frequency are no longer outside of the desired ranges, the system returns to step 2700 to begin the monitoring process again.

As can be understood by the above description of FIG. 27, the system operates to disconnect the refrigeration load from the electricity delivery system when either the voltage or frequency of the electricity delivery system falls below or above set threshold. During the interruption of the electricity supply to limit demand, the monitoring circuit monitors the temperature within the cooled compartment to make sure that food within the compartment does not spoil. If the monitoring circuit determines that food spoilage is imminent, the monitoring circuit reconnects the electricity supply to the appliance to prevent food spoilage. In this manner, the monitoring circuit can both limit demand on the electricity delivery system while preventing food spoilage.

A number of implementations have been described. Nevertheless, it will be understood that various modifications may be made. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

I claim:

1. A method of limiting the demand for electricity from an electricity delivery system by a refrigeration appliance having at least one refrigerated compartment, comprising:
monitoring a characteristic of the electricity delivery system;
interrupting the supply of electricity to the refrigeration appliance when the characteristic exceeds a threshold;
monitoring a sensed condition within the compartment after interruption of the supply of electricity; and
reconnecting the supply of electricity to the refrigeration appliance based upon the sensed condition.

2. The method of claim 1 wherein the sensed condition in the compartment is temperature.

3. The method of claim 1 wherein the characteristic of the electricity delivery system is at least one of voltage or frequency of the electricity.

4. The method of claim 1 further comprising the steps of:
calculating a time when food spoilage will occur within the compartment during the interruption of electricity to the refrigeration appliance based upon the sensed condition; and
reconnecting the supply of electricity to the refrigeration appliance such that the refrigeration appliance can operate to prevent food spoilage.

5. The method of claim 4 wherein the step of calculating when food spoilage will occur includes monitoring the sensed condition over a period of time following the interruption of electricity to the refrigeration appliance.

6. The method of claim 1 further comprising the step of reconnecting the supply of electricity to the refrigeration appliance when the characteristic of electricity no longer exceeds the threshold.

7. The method of claim 1 wherein the refrigeration appliance is reconnected to the supply of electricity to prevent food spoilage in the compartment.

8. The method of claim 1 further comprising the step of operating the refrigeration appliance when the characteristic of electricity exceeds a second threshold.

9. The method of claim 8 wherein the refrigeration appliance is operated to reduce the voltage or frequency along the electricity delivery system.

10. A refrigeration appliance configured to be connected to an electricity delivery system comprising:
at least one compartment configured to receive food;
an appliance controller configured to control operating conditions within the compartment;
a sensor configured to sense a condition within the compartment; and
a monitoring circuit in communication with the sensor and configured to be connected to the electricity delivery system and operable to monitor a characteristic of the electricity delivery system,
wherein the monitoring circuit is operable to disconnect the refrigeration appliance from the electricity delivery system when the condition of the electricity delivery system exceeds a threshold.

11. The refrigeration appliance of claim 10 wherein the sensed condition is temperature.

12. The refrigeration appliance of claim 1O wherein the characteristic of the electricity delivery system is voltage or frequency.

13. The refrigeration appliance of claim 10 wherein the monitoring circuit is operable to determine a time when food spoilage will occur based upon the sensed condition.

14. The refrigeration appliance of claim 13 wherein the monitoring circuit is operable to reconnect the refrigeration appliance to the electricity delivery system to prevent food spoilage based upon the determined time when food spoilage will occur.

15. A method of limiting the demand for electricity from an electricity delivery system by a refrigeration appliance having at least one temperature controlled compartment, comprising:
monitoring a characteristic of the electricity delivery system;
interrupting the supply of electricity to the refrigeration appliance to limit the demand for electricity when the characteristic exceeds a threshold;
monitoring the sensed condition following the interruption of electricity;
determining when food spoilage will occur within the compartment; and
reconnecting the supply of electricity to the refrigeration appliance to prevent food spoilage even when the characteristic exceeds the threshold.

16. The method of claim 15 wherein the sensed condition in the compartment is temperature.

17. The method of claim 16 wherein the step of determining the time when food spoilage will occur includes monitoring the sensed condition over a period of time following the interruption of electricity to the refrigeration appliance.

18. The method of claim 15 further comprising the step of instantaneously engaging the refrigeration appliance when the characteristic of the electricity exceeds a second threshold.
